(19) United States
(12) Patent Application Publication
(10) Pub. No.: US 2020/0040234 A1
(43) Pub. Date: Feb. 6, 2020

(54) CROSS-LINKABLE ADHESIVE COMPOUND

(71) Applicant: TESA SE, Norderstedt (DE)

(72) Inventors: Tobias VON WEDEL-PARLOW, Hamburg (DE); Anna SCHUBERT, Hamburg (DE); Maike STREBL, Hamburg (DE)

(73) Assignee: TESA SE, Norderstedt (DE)

(21) Appl. No.: 16/486,955

(22) PCT Filed: Feb. 20, 2018
(86) PCT No.: PCT/EP2018/054095

§ 371 Date: Aug. 19, 2019

(30) Foreign Application Priority Data
Feb. 20, 2017 (DE) 10 2017 202 668.5

(51) Int. Cl. C09J 151/06; C09J 7/38

(52) U.S. Cl. CPC C09J 151/06; C09J 2451/00; C09J 2205/114; C09J 7/381

(57) ABSTRACT

Pressure sensitive adhesive (PSA) compositions and methods are provided and may comprise a) at least one crosslinkable polymer constructed at least of (i) at least two monomers selected from monomer A, monomer B, and monomer C, wherein each monomer, independently of one another, comprises an olefinically unsaturated aliphatic or cycloaliphatic hydrocarbon, and (ii) at least one comonomer D comprising an olefinically unsaturated monomer having at least one carboxylic acid group and/or carboxylic anhydride group. The PSA compositions and methods may also comprise b) at least one organosilane and c) at least one tackifier resin.

This is a 371 of PCT/EP2018/054095, filed Feb. 20, 2018, which claims foreign priority benefit under 35 U.S.C. § 119 of the German Patent Application No. 10 2017 202 668.5 filed Feb. 20, 2007, the disclosures of which are incorporated herein by reference.

The invention relates to a pressure sensitive adhesive composition comprising crosslinkable polymer with carboxylic acid groups and/or carboxylic anhydride groups, at least one organosilane which is able to enter into a chemical bond with a carboxylic acid group or with a carboxylic anhydride group, and tackifier resin. The invention further relates to a crosslinkable pressure sensitive adhesive composition obtainable by thermal crosslinking of the pressure sensitive adhesive composition, to the use of the pressure sensitive adhesive composition for producing an adhesive tape, and to an adhesive tape comprising at least one layer of the crosslinked pressure sensitive adhesive composition.

Pressure sensitive adhesive compositions (PSAs) have been known for a long time. PSAs are adhesives which even under relatively weak applied pressure permit durable bonding to the substrate and which after use can be detached from the substrate again substantially without residue. PSAs are permanently tacky at room temperature, thus having a sufficiently low viscosity and a high tack, so that they wet the surface of the respective bond base even under low applied pressure. The bondability of the adhesives and the redetachability derives from their adhesive properties and from their cohesive properties. Various compounds are a suitable basis for PSAs.

Adhesive tapes furnished with PSAs, known as pressure sensitive adhesive tapes, are nowadays in diverse use in the industrial and household spheres. Pressure sensitive adhesive tapes consist customarily of a carrier film furnished on one or both sides with a PSA. There are also pressure sensitive adhesive tapes which consist exclusively of a layer of PSA and no carrier film, these being known as transfer tapes. The composition of the pressure sensitive adhesive tapes may differ greatly and is guided by the particular requirements of the different applications. The carriers customarily consist of plastics films such as, for example, polypropylene, polyethylene, polyester, or else of paper, woven fabric or nonwoven.

The self adhesive or pressure sensitive adhesive compositions consist customarily of acrylate copolymers, silicones, natural rubber, synthetic rubber, styrene block copolymers or polyurethanes.

In order to formulate properties appropriate to the application, PSAs may be modified by the admixing of tackifier resins, plasticizers, crosslinkers or fillers.

Fillers are used, for example, to boost the cohesion of a PSA. Frequently in this case a combination of filler/filler interactions and filler/polymer interactions leads to the desired reinforcement of the polymer matrix. Fillers are also admixed for the purpose of increasing weight and/or volume in paper, plastics, and also adhesives and coatings and other products. The addition of filler often improves the technical usefulness of the products and exerts an influence on their quality—for example, strength, hardness, etc. The natural, inorganic and organic fillers, such as calcium carbonate, kaolin, talc, dolomite and the like, are produced mechanically. In the case of rubber and synthetic elastomers as well, suitable fillers can be used to improve the quality—for example, hardness, strength, elasticity and elongation. Fillers widely used are carbonates, especially calcium carbonate, but also silicates (talc, clay, mica), siliceous earth, calcium sulfate and barium sulfate, aluminum hydroxide, glass fibers and glass spheres, and also carbon blacks. Inorganic and organic fillers can also be differentiated according to their density. For instance, the inorganic fillers that are often used in plastics and also adhesives, such as chalk, titanium dioxide, calcium sulfate and barium sulfate, increase the density of the composite, since they themselves have a density which is higher than that of the polymer. For a similar film thickness, the basis weight is then higher. There are also fillers which are able to reduce the overall density of the composite. These include hollow microspheres, very bulky lightweight fillers. The spheres are filled with air, nitrogen or carbon dioxide; the shells of the spheres consist of glass or else, in the case of certain products, of a thermoplastic.

Particularly in the case of applications in the automotive sector, plastics are being used with increasing frequency in place of metals. These plastics generally possess a low surface energy, which makes bonding to these substrates more difficult. Moreover, adhesive bonds are to be as stable as possible with respect to aging and heat. To date, the products used have been primarily based on acrylates (stable to aging, but not adhering well to surfaces with a low surface energy, known as LSE surfaces), SBC synthetic rubbers (adhering well to LSE surfaces, but not heat-resistant) or natural rubber (adhering well to LSE surfaces, but not stable to aging). The LSE surfaces include, in particular, PVA, polystyrene, PE, PP, EVA or Teflon. There is, however, still a lack of solutions which combine all of the good properties.

A surface energy is considered low if it is 50 mN/m or less, preferably less than 40 mN/m, and especially 35 mN/m or less. Where the present text refers to materials having nonpolar surfaces or low-energy surfaces, the materials in question are those having correspondingly low surface energies of 50 mN/m or less, preferably less than 40 mN/m, more preferably still of 35 mN/m or less. The data for surface energies in this text are based on the determination by the method specified in the “Measurement methods” section.

EPDM adhesives are known in the prior art. They are frequently EPDM/thermoplastic blends and are therefore hotmelt adhesives and not PSAs in the sense of the present application. Also known are EPDM-based PSAs, which require a further polymer for setting the pressure-sensitive adhesiveness, and which therefore represent blends. Generally speaking, sufficient shear strength is achieved only through subsequent crosslinking (usually sulfur vulcanization, peroxide crosslinking or phenolic resin crosslinking).

Hence DE 10 2009 046 362 A1 relates to a pressure sensitive adhesive comprising a crosslinkable polyolefin and at least one tackifier resin, in which the polyolefin is composed of at least two monomers A and B and at least one comonomer C amenable to crosslinking, the monomers A and B being selected from the group consisting of α-olefins, vinyl acetate, n-butyl acrylate and methyl methacrylate or, in the case of EPDM, a diene such as 5-ethylidene-2-norbornene, dicyclopentadiene or 5-vinyl-2-norbornene. DE 10 2009 046 363 A1 relates to an adhesive assembly tape for interior outfitting, composed of a carrier and an adhesive which is coated from the melt onto at least one side of said carrier and which comprises an ethylene-propylene rubber, such as EPDM, for example, having a density of between 0.86 and 0.89 g/cm³, and a tackifier resin. The adhesives disclosed in these applications do have a high peel adhesion even on LSE surfaces and also a high aging stability, but their shear strength, even after they have been crosslinked, is in need of further improvement.

The as yet unpublished application DE 10 2015 217 376 relates to a PSA which comprises as base polymer at least one or more solid EPDM rubbers and also tackifier resins, the fraction of the tackifier resins being 30 to 130 phr and the adhesive being plasticizer-free.

The likewise as yet unpublished application DE 10 2015 224 734 relates to a composition for producing a pressure sensitive adhesive composition, comprising

a) at least one crosslinkable poly(meth)acrylate,
b) at least one organosilane conforming to the formula (1)

R¹—Si(OR²)ₙR³ₘ (1),

in which R¹ is a radical containing a cyclic ether function,
the radicals R² independently of one another are each an alkyl or acyl radical,
R³ is a hydroxyl group or an alkyl radical,
n is 2 or 3, and m is the number resulting from 3-n; and
c) at least one substance accelerating the reaction of the crosslinkable poly(meth)acrylate with the cyclic ether functions. In view of the ester functionalities of the poly(meth)acrylate, (meth)acrylate-based PSAs generally have insufficient peel adhesion to nonpolar substrates.

It is an object of the present invention, relative to the prior-published state of the art, to provide a pressure sensitive adhesive composition for, for example, an adhesive tape, that has a high peel adhesion, not least to LSE surfaces, and customarily has a high aging stability, and which further, through crosslinking, results in an adhesive of good shear strength, including, in particular, under hot conditions.

This object is achieved by means of a pressure sensitive adhesive composition set forth hereinafter. This pressure sensitive adhesive composition comprises

a) at least one crosslinkable polymer, the polymer being constructed at least of (i) at least two monomers A and B, such as, for example, three monomers A, B and C, which in each case independently of one another comprise an olefinically unsaturated aliphatic or cycloaliphatic hydrocarbon, and (ii) at least one comonomer D, which comprises an olefinically unsaturated monomer having at least one carboxylic acid group and/or carboxylic anhydride group,
b) at least one organosilane conforming to the formula (1)

R¹—Si(OR²)ₙR³ₘ (1),

in which R¹ is a radical which is able to enter into a chemical bond with a carboxylic acid group or with a carboxylic anhydride group,
the radicals R² independently of one another are each a hydrogen, an alkyl, a cycloalkyl, an aryl or an acyl radical,
R³ is a hydrogen, an alkyl, a cycloalkyl or an aryl radical,
n is 2 or 3, and
m is the number resulting from 3-n, and
c) at least one tackifier resin.

The PSA enables the production of adhesive tapes which have a high peel adhesion, both to LSE surfaces and to polar surfaces such as, for example, metal, PVC, polycarbonate, plexiglass or paint surfaces. Thus adhesive tapes based on the PSA of the invention exhibit in particular a high peel strength. The adhesive tapes, furthermore, are stable to aging. Moreover, the crosslinking of the PSA enables the provision of adhesive tapes featuring high shear strength. The adhesive tapes based on the PSA of the invention have a high shear strength even at high temperatures, and are therefore heat-stable.

Preferred embodiments of the PSA of the invention are further set forth hereinafter.

The invention also relates to a crosslinked PSA which can be obtained by thermal crosslinking of a PSA of the invention.

The invention further relates to the use of a PSA of the invention for producing an adhesive tape, where a carrier is coated with the PSA and the PSA is thermally crosslinked, to give a layer of a crosslinked PSA.

The invention relates, moreover, to an adhesive tape which comprises at least one layer of a crosslinked PSA of the invention.

A “pressure sensitive adhesive composition” is understood in accordance with the invention, as is customary within the general usage, as a material which—in particular at room temperature—is permanently tacky and also adhesive. Characteristics of a pressure sensitive adhesive are that it can be applied by pressure to a substrate and remains adhering there, with no further definition of the pressure to be applied or the period of exposure to this pressure. In certain cases, depending on the precise nature of the pressure sensitive adhesive, the temperature, and the atmospheric humidity and also the substrate, a minimal pressure of short duration, which does not go beyond gentle contact for a brief moment, is enough to achieve the adhesion effect, while in other cases a longer-term period of exposure to a high pressure may be necessary.

Pressure sensitive adhesives have particular, characteristic viscoelastic properties which result in the permanent tack and adhesiveness. A characteristic of these adhesives is that when they are mechanically deformed, there are processes of viscous flow and there is also development of elastic forces of recovery. The two processes have a certain relationship to one another in terms of their respective proportion, in dependence not only on the precise composition, the structure, and the degree of crosslinking of the pressure sensitive adhesive, but also on the rate and duration of the deformation, and on the temperature.

The proportional viscous flow is necessary for the achievement of adhesion. Only the viscous components, brought about by macromolecules with relatively high mobility, permit effective wetting and effective flow onto the substrate where bonding is to take place. A high viscous flow component results in high tack (also referred to as surface stickiness) and hence often also in a high peel adhesion. Highly crosslinked systems, crystalline polymers, or polymers with glasslike solidification lack flowable components and are therefore in general devoid of tack or possess only little tack at least.

The proportional elastic forces of recovery are necessary for the attainment of cohesion. They are brought about, for example, by very long-chain macromolecules with a high degree of coiling, and also by physically or chemically crosslinked macromolecules, and they allow the transmission of the forces that act on an adhesive bond. As a result of these forces of recovery, an adhesive bond is able to withstand a long-term load acting on it, in the form of a long-term shearing load, for example, sufficiently over a relatively long time period.

For the more precise description and quantification of the extent of elastic and viscous components, and also of the relationship between the components, it is possible to employ the variables of storage modulus (G′) and loss modulus (G″), which can be determined by means of Dynamic Mechanical Analysis (DMA). G′ is a measure of the elastic component, G″ a measure of the viscous component, of a substance. Both variables are dependent on the deformation frequency and the temperature.

The variables can be determined with the aid of a rheometer. In that case, for example, the material under investigation is exposed in a plate/plate arrangement to a sinusoidally oscillating shear stress. In the case of instruments operating with shear stress control, the deformation is measured as a function of time, and the time offset of this deformation is measured relative to the introduction of the shear stress. This time offset is referred to as phase angle δ.

The storage modulus G′ is defined as follows: G′=(τ/γ)·cos(δ) (τ=shear stress, γ=deformation, δ=phase angle=phase shift between shear stress vector and deformation vector). The definition of the loss modulus G″ is as follows: G″=(τ/γ)·sin(δ) (τ=shear stress, γ=deformation, δ=phase angle=phase shift between shear stress vector and deformation vector).

A substance is considered in general to be pressure-sensitively adhesive, and is defined as being pressure-sensitively adhesive for the purposes of the invention, if at room temperature, presently by definition at 23° C., in the deformation frequency range from 10° to 10¹ rad/sec, G′ is located at least partly in the range from 10³ to 10⁷ Pa and if G″ likewise is located at least partly within this range. “Partly” means that at least one section of the G′ curve lies within the window described by the deformation frequency range from 10° inclusive up to 10¹ inclusive rad/sec (abscissa) and by the G′ value range from 10³ inclusive up to 10⁷ inclusive Pa (ordinate). For G″ this applies correspondingly.

In accordance with the invention a “hydrocarbon” is a compound which consists of carbon and hydrogen.

An “olefinically unsaturated” compound (such as, for example, an “olefinically unsaturated” hydrocarbon or an “olefinically unsaturated” monomer) means a compound having at least one C═C double bond (an aromatic such as benzene or an alkyne such as ethyne, for example, is accordingly not an olefinically unsaturated compound in accordance with the invention).

The radical R¹ of the organosilane is able to enter into a chemical bond with a carboxylic acid group or with a carboxylic anhydride group, preferably at elevated temperature. A “chemical bond” in this context refers in particular to a bond which is predominantly covalent. A bond is predominantly covalent when its covalent fraction is greater than its ionic fraction or when its covalent fraction is 100%. The entering of the radical R¹, of the organosilane present in the PSA of the invention, into such a chemical bond with a carboxylic acid group or with a carboxylic anhydride group, of the crosslinkable polymer likewise present in the PSA, leads to the crosslinking of PSA, together with the condensation reaction of the hydrolyzable silyl groups of the organosilane with one another.

The PSA of the invention did not need any further addition of water or exposure to atmospheric moisture for crosslinking; after just a short time, the desired degree of crosslinking of the product was achieved. The residual moisture typically present in the crosslinkable polymer was therefore sufficient for the crosslinking, if needed for the crosslinking. Furthermore, the reaction of the radical R¹ of the organosilane with the carboxylic acid or carboxylic anhydride of the crosslinkable polymer may lead to the formation of water, which accelerates the crosslinking. Increasing the atmospheric moisture during storage likewise resulted in an acceleration of the crosslinking reaction. Alternatively, water may be added to the PSA of the invention. A water-containing PSA of the invention of this kind may likewise be crosslinked with acceleration.

In the crosslinkable polymer of the PSA of the invention, the at least two monomers A and B, such as, for example, three monomers A, B and C, independently of one another are preferably an α-olefin having 2 to 8 carbon atoms, such as ethylene, propylene, 1-hexene or 1-octene, or a diene, such as 5-ethylidene-2-norbornene (ENB), dicyclopentadiene or 5-vinyl-2-norbornene for example. In particular, the monomer A is ethylene, the monomer B is propylene, and the monomer C, if present, is a diene, such as, for example, 5-ethylidene-2-norbornene (ENB), dicyclopentadiene or 5-vinyl-2-norbornene, with 5-ethylidene-2-norbornene (ENB) being a particularly preferred diene. This means that in accordance with the invention the crosslinkable polymers are, in particular, polymers based on EPDM or EPM. The crosslinkable polymer is typically an elastomeric polymer. The polymer customarily possesses an extremely low degree of crystallinity and does not possess any defined melting point, as is the case, for example, with thermoplastic polymers. In particular the crosslinkable polymer is amorphous.

The comonomer D of the crosslinkable polymer used in accordance with the invention is preferably acrylic acid, methacrylic acid, maleic acid, maleic anhydride, fumaric acid, fumaric anhydride, methylmaleic acid, methylfumaric acid, itaconic acid, crotonic acid, crotonic anhydride, 4-methylcyclohex-4-ene-1,2-dicarboxylic anhydride, bicyclo[2.2.1]hept-5-ene-2,3-dicarboxylic anhydride, bicyclo[2.2.1]hept-5-ene-2,3-dicarboxylic acid, bicyclo[2.2.2]oct-5-ene-2,3-dicarboxylic acid, bicyclo[2.2.2]oct-5-ene-2,3-dicarboxylic anhydride, bicyclo[2.2.2]oct-7-ene-2,3,5,6-tetracarboxylic acid, bicyclo[2.2.2]oct-7-ene-2,3,5,6-tetracarboxylic anhydride, 5-norbornene-2,3-dicarboxylic acid, norborn-5-ene-2,3-dicarboxylic anhydride, tetrahydrophthalic acid or tetrahydrophthalic anhydride, preferably acrylic acid, maleic acid, maleic anhydride, fumaric acid or fumaric anhydride, and in particular maleic anhydride. A high fraction of carboxylic acid groups in the crosslinkable polymer results in particularly high adhesion of the resultant PSA to polar substrates and in a high degree of crosslinking. Such PSAs are frequently impossible to peel off again. Carboxylic anhydride-containing crosslinkable polymers customarily have a low acid content, and so the resultant PSA is potentially also able to be peeled off again from polar substrates.

The crosslinkable polymer may be obtained, for example, by copolymerization at least of the at least two monomers A and B, such as, for example, the three monomers A, B and C, to give a polymer, and grafting of the comonomer D onto the polymer. This means that in the resulting polymer, the comonomer D is grafted on a polymer which is at least composed of the at least two monomers A and B, such as, for example, the three monomers A, B and C. The grafting may take place by processes familiar to the skilled person. In this respect, reference is made to the textbook M. D. Lechner, K. Gehrke, E. H. Nordmeier: “Makromolekulare Chemie”, 5^{th} edition, Springer Verlag Berlin Heidelberg, 2014, p. 27 and pp. 147 to 150, the content being hereby incorporated into this application. Further, with regard to the grafting of ethylenically unsaturated carboxylic acids and/or carboxylic acid derivatives onto polyolefins, reference is made to U.S. Pat. No. 6,894,115 B2, U.S. Pat. No. 5,604,033, and EP 0369604 A2, the content of which is hereby likewise incorporated into this application. Reference in this regard is also made to Oostenbrink, A. J., Gaymanns, R. J.: “maleic anhydride grafting on EPDM Rubber in the melt”, Twente University of Technology, October 1990, and also Kang et al: “Preparation of maleated ethylene-propylene-diene terpolymer modified with a,o-Aminopropyl polydimethylsiloxane”, Journal of industrial and engineering chemistry, Vol. 6, No. 4, July 2000, 270-275, the content of which is hereby likewise incorporated into this application.

The crosslinkable polymer may alternatively be obtained, for example, by copolymerization at least of the at least two monomers A and B, such as, for example, the three monomers A, B and C, with the comonomer D. This means that in the resulting polymer, the comonomer D is incorporated by polymerization in a polymer which is at least composed of the at least two monomers A and B, such as, for example, the three monomers A, B and C.

The copolymerization of the monomers A, B and optionally C and/or D may likewise take place by processes familiar to the skilled person, more particularly by the metallocene-catalyzed or Ziegler-Natter-catalyzed polymerization and activation by aluminum alkyl compounds. The polymerization in this case takes place under pressure for example in low-boiling solvents (especially hydrocarbons) or as a suspension polymerization in one of the liquefied monomers (for example, propylene). Another possibility, moreover, is that of polymerizing the monomers in the gas phase over a fixed bed of catalyst. In all cases, excess monomers and any solvents used can be subsequently removed efficiently by expansion of the reaction mixture.

The crosslinkable polymer is composed preferably to an extent of 45 to 99.9 wt %, more preferably 70 to 99.5 wt %, of the at least two monomers A and B, such as, for example, the three monomers A, B and C, to an extent of 0.1 to 15 wt %, more preferably 0.5 to 5 wt %, especially 1 to 3 wt %, of the comonomer D, and to an extent of 0 to 40 wt %, more preferably 0 to 20 wt %, of at least one further olefinically unsaturated monomer E, which is copolymerizable with the other monomers, based in each case on the total weight of the underlying monomer composition.

In principle it is possible as monomer E to use any vinylically functionalized compound which is copolymerizable with the other monomers. The monomer E is preferably selected from methyl acrylate, ethyl acrylate, propyl acrylate, methyl methacrylate, ethyl methacrylate, benzyl acrylate, benzyl methacrylate, phenyl acrylate, phenyl methacrylate, isobornyl acrylate, isobornyl methacrylate, tert-butylphenyl acrylate, tert-butylphenyl methacrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofurfuryl acrylate, N,N-diethylaminoethyl acrylate, N,N-diethylaminoethyl methacrylate, N,N-dimethylaminoethyl acrylate, N,N-dimethylaminoethyl methacrylate, methyl 3-methoxy acrylate, 3-methoxybutyl acrylate, butyl diglycol methacrylate, ethylene glycol acrylate, ethylene glycol monomethyl acrylate, methoxypolyethylene glycol methacrylate 350, methoxypolyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,3,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethylamino-propylacrylamide, dimethylaminopropylmethacrylamide, N-(1-methylundecyl)acrylamide, N-(n-butoxymethyl)acrylamide, N-(butoxymethyl)methacrylamide, N-(ethoxymethyl)acryl-amide, N-(n-octadecyl)acrylamide; N,N-dialkyl-substituted amides such as, for example, N,N-dimethylacrylamide, N,N-dimethylmethacrylamide; N-benzylacrylamide, N-isopropylacrylamide, N-tert-butylacrylamide, N-tert-octylacrylamide, N-methylolacrylamide, N-methylolmethacrylamide; acrylonitrile, methacrylonitrile; vinyl ethers such as vinyl methyl ether, ethyl vinyl ether, vinyl isobutyl ether; vinyl esters such as vinyl acetate; vinyl chloride, vinyl halides, vinylidene chloride, vinylidene halides, vinylpyridine, 4-vinylpyridine, N-vinylphthalimide, N-vinyllactam, N-vinylpyrrolidone, styrene, o- and p-methylstyrene, a-butylstyrene, 4-n-butylstyrene, 4-n-decylstyrene, 3,4-dimethoxystyrene, macromonomers such as 2-polystyrene-ethyl methacrylate, and poly(methyl methacrylate)ethyl methacrylate.

The monomer E may also advantageously be selected to contain one or more functional groups which support subsequent radiation crosslinking (by electron beams, UV, for example). Suitable copolymerizable photoinitiators are, for example, benzoin acrylate and acrylate-functionalized benzophenone derivative monomers, tetrahydrofurfuryl acrylate, N-tert-butylacrylamide and allyl acrylate.

The crosslinkable polymer present in the PSA of the invention is preferably composed to an extent of 30 to 80 wt %, more preferably 40 to 70 wt %, especially 45 to 60 wt %, of ethylene, based in each case on the total weight of the underlying monomer composition.

Also preferably the crosslinkable polymer is composed to an extent of 20 to 60 wt %, preferably of 30 to 50 wt %, of propylene, based in each case on the total weight of the underlying monomer composition.

Furthermore, the crosslinkable polymer is composed preferably to an extent of 0 to 20 wt %, more preferably 5 to 10 wt %, of diene, based in each case on the total weight of the underlying monomer composition.

The crosslinkable polymer preferably has a Mooney viscosity (ML 1+4/125° C.) of more than 25, preferably of more than 30, more preferably still of more than 45, and especially of more than 55. The Mooney viscosity (ML 1+4/125° C.) here is measured in each case according to DIN 53523.

In the PSA there is preferably 25 to 60 wt %, more preferably 30 to 50 wt %, of crosslinkable polymer, based in each case on the total weight of the PSA.

The PSA of the invention comprises at least one organosilane conforming to the formula (1)

R¹—Si(OR²)ₙR³ₘ (1),

in which R¹ is a radical which is able to enter into a chemical bond with a carboxylic acid group or with a carboxylic anhydride group,
the radicals R² independently of one another are each a hydrogen, an alkyl, a cycloalkyl, an aryl or an acyl radical,
R³ is a hydrogen, an alkyl, a cycloalkyl or an aryl radical,
n is 2 or 3, and
m is the number resulting from 3-n.

Organosilanes of this kind are able to react with—that is, enter into a chemical bond, such as, more particularly, a predominantly covalent bond, with—the carboxylic acid groups or the carboxylic anhydride groups of the crosslinkable polymer, preferably at elevated temperature. Carboxylic anhydride groups of a crosslinkable polymer, depending on radical R¹, may therefore already react as such with the radical R¹ and/or may react with the radical R¹ via the ring-opened form of the anhydride. This form is obtainable in particular by hydrolysis, i.e., by reaction with water present in the PSA. Entry into a chemical bond of this kind between the radical R¹ of the organosilane and a carboxylic acid group or a carboxylic anhydride group of the crosslinkable polymer leads, together with the condensation reaction of the hydrolyzable silyl groups of the organosilane with one another, to the crosslinking of the PSA. In accordance with the invention there is not only a linking of the carboxylic acid groups and/or carboxylic anhydride groups of the crosslinkable polymers to the radicals R¹ of the organosilanes, but also condensation reactions of the hydrolyzable silyl groups of the organosilanes conforming to the formula (1) with one another. In this way the organosilanes conforming to the formula (1) enable a linking of the polymers to one another, and are incorporated into the network resulting from this linking.

The radicals R² of the organosilane of the formula (1) independently of one another are preferably each an alkyl group or acetyl group, and more preferably an alkyl group, the alkyl group being preferably a methyl, ethyl, propyl or isopropyl group, more preferably a methyl or ethyl group, and especially an ethyl group. Alkoxy groups, and especially methoxy and ethoxy groups, are quick and easy to hydrolyze, and the alcohols which form as cleavage products are comparatively easy to remove from the composition, and frequently have no critical toxicity.

The radical R³ of the organosilane of the formula (1), if present, is preferably an alkyl group, the alkyl group being preferably a methyl, ethyl, propyl or isopropyl group, and especially a methyl group.

The radical R¹ of the organosilane of the formula (1) preferably contains at least one hydroxyl group, at least one thio group, at least one amino group NHR⁴, in which R⁴ is a hydrogen, alkyl, cycloalkyl or aryl radical, or a mixture thereof, and, if R⁴ is an alkyl or cycloalkyl radical, this radical optionally comprises at least one further amino group NHR⁴, at least one hydroxyl group, at least one thio group or a mixture thereof. More preferably R¹ contains at least one amino group NHR⁴. The stated radicals R¹ are capable in particular of reacting with carboxylic anhydride groups even without prior ring opening. Moreover, the reaction of organosilanes which contain a radical R¹ which comprises an amino group NHR⁴ with crosslinkable polymer according to the invention results in amide compounds, which are considered to be particularly stable.

The radical R¹ here is preferably a radical X—(CH₂)—(CH₂)ₚ, where X is a hydroxyl group, a thio group or an amino group NHR⁴, in which R⁴ is a hydrogen, alkyl, cycloalkyl or aryl radical, and p is an integer from 0 to 10 and especially from 0 to 2, and, if R⁴ is an alkyl or cycloalkyl radical, it optionally comprises at least one further amino group NHR⁴, at least one hydroxyl group, at least one thio group or a mixture thereof. More preferably the organosilane of the formula (1) is N-cyclohexyl-3-aminopropyltrimethoxysilane (CAS No. 3068-78-8, e.g. from Wacker), N-cyclohexylaminomethyltriethoxysilan (CAS No. 26495-91-0, e.g. from Wacker), 3-aminopropyltrimethoxysilane (CAS No. 13822-56-5, e.g. from Gelest Inc.), 3-aminopropyltriethoxysilane (CAS No. 919-30-2, e.g. from Gelest Inc.), 3-aminopropylmethyldiethoxysilane (CAS No. 3179-76-8, e.g. from Gelest Inc), 3-(2-aminomethylamino)propyltriethoxysilane (CAS No. 5089-72-5, e.g. from Wacker) or a mixture thereof.

The radical R¹ of the organosilane of the formula (1) may alternatively be, for example, a radical containing at least one cyclic ether function. R¹ preferably contains at least one epoxide group, at least one oxetane group or a mixture thereof, and more preferably at least one epoxide group. More preferably still, R¹ contains at least one glycidyloxy group, at least one epoxycyclohexyl group such as, for example, a 3,4-epoxycyclohexyl group, at least one epoxyhexyl group such as, for example, a 5,6-epoxyhexyl group, at least one oxetanylmethoxy group such as, for example, a 3-oxetanylmethoxy group, or a mixture thereof; the radical R¹ here is preferably a radical Y—(CH₂)—(CH₂)_{q}, where Y is such a group, and q is in anteger from 0 to 10 and especially from 0 to 2. More preferably the organosilane of the formula (1) is (3-glycidyloxypropyl)trimethoxysilane (CAS No. 2530-83-8, e.g. Dynasylan® GLYMO, Evonik), (3-glycidyloxypropyl)triethoxysilane (CAS No. 2602-34-8, e.g. Dynasylan® GLYEO, Evonik), (3-glycidyloxypropyl)methyldimethoxysilane (CAS No. 65799-47-5, e.g. from Gelest Inc.), (3-glycidoxypropyl)methyldiethoxysilane (CAS No. 2897-60-1, e.g. from Gelest Inc.), 5,6-epoxyhexyltriethoxysilane (CAS No. 86138-01-4, e.g. from Gelest Inc.), [2-(3,4-epoxycyclohexyl)ethyl]trimethoxysilane (CAS No. 3388-04-3, e.g. from Sigma-Aldrich), [2-(3,4-epoxycyclohexyl)ethyl]triethoxysilane (CAS No. 10217-34-2, e.g. from ABCR GmbH), triethoxy[3-[(3-ethyl-3-oxetanyl)methoxy]propyl]silane (CAS No. 220520-33-2, e.g. Aron Oxetane OXT-610, Toagosei Co., Ltd.) or a mixture thereof. Organosilanes with cyclic ether function have the advantage in particular that they exhibit a pronounced stability.

According to one preferred embodiment, the PSA of the invention comprises in addition to (i) at least one organosilane whose radical R¹ comprises at least one hydroxyl group, at least one thio group, at least one amino group NHR⁴, with R⁴ as defined above, or a mixture thereof, also (ii) at least one organosilane whose radical R¹ is a radical containing at least one cyclic ether function.

The PSA preferably comprises the at least one organosilane conforming to the formula (1) at in total 0.05 to 2 wt %, more preferably at in total 0.2 to 1 wt % and especially at 0.5 to 0.8 wt %, based in each case on the total weight of the PSA.

In accordance with the invention, in addition to the at least one organosilane conforming to the formula (1), there may also be polyfunctional epoxides or oxetanes present as crosslinkers in the PSA of the invention. These compounds are preferably selected from 1,4-butanediol diglycidyl ether, polyglycerol-3 glycidyl ether, cyclohexanedimethanol diglycidyl ether, glycerol triglycidyl ether, neopentyl glycol diglycidyl ether, pentaerythritol tetraglycidyl ether, 1,6-hexanediol diglycidyl ether, polypropylene glycol diglycidyl ether, trimethylolpropane triglycidyl ether, bisphenol A diglycidyl ether, bisphenol F diglycidyl ether, bis[1-ethyl(3-oxetanyl)]methyl ether, 2,4:3,5-dianhydrido-1,6-di-O-benzoylmannitol, and 1,4-bis[2,2-dimethyl-1,3-dioxolan-4-yl]-3,3-dimethyl-2,5-dioxabicyclo[2.1.0]pentane.

In accordance with the invention, additionally to the at least one organosilane conforming to the formula (1), there may alternatively also be polyfunctional amines, alcohols or thiols present, preferably polyfunctional amines such as, for example, diethylenetriamine or triethylenetetramine, as crosslinkers in the PSA of the invention.

The PSA of the invention may further comprise at least one substance which accelerates the crosslinking (accelerator). Substance with accelerating effect means in particular that the substance supports the first crosslinking reaction—the attachment of the radical R¹ to the polymer—so as to achieve an increased reaction rate. An accelerator of this kind is per se also capable of accelerating the hydrolysis of the organic silane in the presence of moisture, and the subsequent condensation reaction of the resultant silanols. The accelerator is therefore able to provide a substantial improvement in the kinetics of the crosslinking reaction. In accordance with the invention this may take place catalytically, but also by incorporation into the reaction events. If present, therefore, the accelerator substance has an accelerating effect on the overall crosslinking mechanism.

Particularly if the radical R¹ of the organosilane of the formula (1) is a radical containing at least one cyclic ether function, the accelerating substance, if present, comprises preferably at least one basic function, more preferably at least one amino group, or is an organic amine. In the case of an organic amine, starting from ammonia, at least one hydrogen atom is replaced by an organic group, in particular by an alkyl group. Preferred among the amino groups and/or amines are those which do not enter into chemical bonds, or form such bonds only very slowly, with the crosslinkable polymers, especially their carboxylic acid groups or carboxylic anhydride groups. Slow formation of the chemical bonds in this context means that the chemical bonds are entered into substantially more slowly than the activation of the cyclic ether functions. Suitable in principle are primary (NRH₂), secondary (NR₂H) and tertiary (NR₃) amines, including of course those which have two or more primary and/or secondary and/or tertiary amino groups, such as diamines, triamines and/or tetramines. Examples of suitable accelerators are pyridine, imidazoles (such as, for example, 2-methylimidazole), 1,8-diazabicyclo[5.4.0]undec-7-ene, cyclo-aliphatic polyamines, isophoronediamine, or phosphate-based accelerators such as phosphines and/or phosphonium compounds, as for example triphenylphosphine or tetraphenylphosphonium tetraphenylborate.

Particularly if the radical R¹ of the organosilane of the formula (1) comprises at least one hydroxyl group, at least one thio group, at least one amino group NHR⁴, in which R⁴ is as defined above, or a mixture thereof, the accelerating substance, if present, preferably comprises at least one acidic function.

If the PSA of the invention comprises an accelerating substance, that substance is present in the PSA preferably in an amount of 0.05 to 1 wt %, based on the total weight of the PSA.

For the statement of the crosslinking proportions it is possible in particular to employ the ratio of the number of functional groups in the radical R¹ of the organosilanes conforming to the formula (1) that are able to enter into a chemical bond with a carboxylic acid or a carboxylic anhydride, to the number of carboxylic acid groups or carboxylic anhydride groups in the crosslinkable polymers. In principle this ratio is freely selectable, and hence there is either an excess of carboxylic acid (anhydride) groups on the part of the crosslinkable polymers, numerical equality of the groups, or an excess of functional groups in the radicals R¹ of the organosilanes. This ratio is preferably selected such that the functional groups of the organosilanes conforming to the formula (1) that are able to enter into a chemical bond with a carboxylic acid or carboxylic anhydride are in deficit to at most in numerical equality. With particular preference the ratio of the total number of said functional groups of the organosilanes conforming to the formula (1) to the number of carboxylic acid or carboxylic anhydride groups that are reactive toward them in the crosslinkable polymers is 0.05:1 to 1:1. In addition, the properties of the PSA obtained after crosslinking has taken place—and especially its elasticity—can also be adjusted by way of the number of water-eliminable groups in the organosilanes conforming to the formula (1), and also, if present, by way of the amount of the polyfunctional epoxides or oxetanes, the polyfunctional amines, alcohols or thiols, or the accelerator substances.

The PSA of the invention comprises at least one tackifier resin. A “tackifier resin” refers, in accordance with the general understanding of the skilled person, conventionally to a low molecular mass, oligomeric or polymeric resin which raises the adhesion (the tack, the intrinsic stickiness) of the PSA in comparison to the otherwise identical PSA containing no tackifier resin. The tackifier resin is preferably selected from aliphatic, aromatic and alkylaromatic hydrocarbon resins, at least partly hydrogenated hydrocarbon resins, functional hydrocarbon resins, and natural resins. Hydrocarbon resins are highly compatible. More preferably the tackifier resin is selected from pinene resins, indene resins and rosins, their disproportionated, hydrogenated, dimerized, polymerized and/or esterified derivatives and salts, terpene resins and terpene-phenolic resins, and also C5, C9 and other hydrocarbon resins. Combinations of these and further resins may also be used advantageously to bring the properties of the resultant PSA into line with requirements. Resins based on rosin or rosin derivatives, preferably partially or entirely hydrogenated, are particularly suitable. They have the greatest tack (stickiness, grab) of all tackifier resins. Terpene-phenolic resins are likewise particularly suitable; while the resulting tack is moderate, they result in very good shear strength and aging resistance. In particular the tackifier resin is compatible with—meaning essentially “soluble in”—the crosslinkable polymers of the PSA of the invention.

The PSA of the invention comprises preferably 30 to 70 wt %, more preferably 40 to 60 wt %, and especially 40 to 50 wt % of tackifier resin, based in each case on the total weight of the PSA.

The PSA, if it is to be particularly tacky, may comprise a preferably liquid plasticizer, such as, for example, an aliphatic (paraffinic or branched), cycloaliphatic (naphthenic) or aromatic mineral oil, an ester of phthalic, trimellitic, citric or adipic acid, a liquid rubber (for example low molecular mass nitrile rubber, butadiene rubber or polyisoprene rubber), a liquid polymer of isobutene and/or butene, or a liquid resin or plasticizing resin having a softening point below 40° C., based on the raw materials of tackifier resins, particularly on the above-recited classes of tackifier resin. Particularly preferred is the use of liquid isobutene polymer, such as, for example, an isobutene homopolymer or an isobutene-butene copolymer, or a liquid resin or plasticizing resin having a softening point below 40° C. Mineral oils are very inexpensive and are highly suited for formulating tack in the crosslinkable polymer, but may migrate into bond substrates such as paper; consequently, in one embodiment, the pressure sensitive adhesive is substantially free of mineral oils.

In one preferred embodiment, the PSA of the invention comprises 5 to 25 wt %, more preferably 10 to 20 wt %, and especially 10 to 15 wt % of plasticizers, especially liquid plasticizers, based in each case on the total weight of the PSA.

In another preferred embodiment, the PSA of the invention may comprise not only the at least one crosslinkable polymer but additionally at least one other polymer, present as a mix or blend with the crosslinkable polymer. For example, the PSA may comprise at least one polymer selected from natural rubber, synthetic rubber, EVA, silicone rubber, acrylic rubber and polyvinyl ether. These polymers are added preferably before the thermal crosslinker is added. The polymer blends are produced preferably in an extruder, more preferably in a multiscrew extruder or in a planetary roll mixer, as described in DE 19806609 A1, for example.

In particular, in addition to the at least one crosslinkable polymer, the PSA of the invention may comprise at least one polymer which is composed at least of at least two monomers A and B, such as, for example, three monomers A, B and C, as set forth herein. In this case, the monomer A is preferably ethylene, the monomer B is preferably propylene, and the monomer C, if present, is preferably a diene, such as, for example, 5-ethylidene-2-norbornene (ENB), dicyclopentadiene or 5-vinyl-2-norbornene. More particularly the additional polymer is composed of ethylene, propylene and optionally a diene, where the diene, if present, is preferably 5-ethylidene-2-norbornene (ENB), dicyclopentadiene or 5-vinyl-2-norbornene, and especially 5-ethylidene-2-norbornene (ENB). This means that the additional polymer is preferably an EPM or EPDM rubber without further functionalization.

The polymer optionally present additionally in the PSA is preferably composed to an extent of 30 to 80 wt %, more preferably 40 to 70 wt %, especially 45 to 60 wt %, of ethylene, based in each case on the total weight of the parent monomer composition. Preferably also the polymer is composed to an extent of 20 to 60 wt %, more preferably 30 to 50 wt %, of propylene, based in each case on the total weight of the parent monomer composition. Also preferably the polymer is composed to an extent of 0 to 20 wt %, more preferably 5 to 10 wt %, of diene, based in each case on the total weight of the parent monomer composition.

The polymer optionally present additionally in the PSA of the invention as well as the crosslinkable polymer may be solid or liquid. It preferably possesses a Mooney viscosity (ML 1+4/125° C.) of less than 25. This Mooney viscosity (ML 1+4/125° C.) is measured in accordance with DIN 53523. With particular preference the polymer is liquid.

By way of a polymer which is optionally present additionally in the PSA as well as the crosslinkable polymer, and which is at least composed of at least two monomers A and B, such as, for example, three monomers A, B and C, as set forth herein, it is possible to adjust properties of the PSA, especially its tack, both before and after it has been crosslinked. Liquid polymers in particular that are composed of ethylene, propylene and optionally a diene, in other words EPM or EPDM rubbers which are liquid and without further functionalization, may impart outstanding tack to the PSA. The tack of such PSAs is typically further improved relative to PSAs in which other plasticizers are used.

In one preferred embodiment, the PSA of the invention, besides the crosslinkable polymer, comprises 5 to 30 wt %, more preferably 10 to 25 wt %, and especially 10 to 20 wt %, of liquid polymer composed of ethylene, propylene and optionally a diene, based in each case on the total weight of the PSA.

The PSA of the invention may further comprise one or more additives. It may, for example, comprise filler, dye or pigment such as, for example, chalk (CaCO₃), titanium dioxide, zinc oxide and/or carbon black. These substances are known in particular for their reinforcing and/or abrasive effect. The stated substances may also be present in the PSA in high proportions, in other words up to 50 wt %, based on the total weight of the PSA.

The PSA of the invention may further comprise as additives, for example, low-flammability fillers such as, for example, ammonium polyphosphate and aluminum diethylphosphinate; electrically conductive fillers such as, for example, conductive carbon black, carbon fibers and/or silver-coated beads); thermally conductive materials such as, for example, boron nitride, aluminum oxide, silicon carbide; ferromagnetic additives, such as, for example, iron(III) oxides; additives for increasing volume, especially for producing foamed layers, such as, for example, expandants, solid glass spheres, hollow glass spheres, microspheres made of other materials, expandable microballoons, silica, silicates, organically renewable raw materials, as for example wood flour, organic and/or inorganic nanoparticles, fibers, aging inhibitors, light stabilizers, antiozonants and/or compounding agents. Hollow glass spheres and expandable microballoons are preferred additives, with expandable microballoons being particularly preferred. Aging inhibitors which can be used include both primary—e.g., 4-methoxyphenol—and secondary aging inhibitors, e.g., Irgafos® TNPP from BASF, including in combination with one another; and also phenothiazine (C-radical scavenger) or hydroquinone methyl ether in the presence of oxygen, and also oxygen itself.

A further aspect of the invention relates to a process for producing and crosslinking a pressure sensitive adhesive composition of the invention, said process comprising heating the pressure sensitive adhesive composition of the invention to a temperature sufficient to initiate the crosslinking reaction. Correspondingly, a further aspect of the invention is a crosslinked pressure sensitive adhesive composition obtainable by thermally crosslinking a pressure sensitive adhesive composition of the invention.

Within the process of the invention, the crosslinking is preferably initiated in the melt of the PSA of the invention, and the melt thereafter is processed further at a point in time at which it is not yet too viscous and therefore outstandingly workable—that is, for example, being amenable to homogeneous coating and/or shaping. For adhesive tapes in particular, a homogeneous, uniform coated aspect is needed; there should be no lumps, specks or the like to be found in the layer of adhesive. Correspondingly homogeneous polymers are also required for the other forms of application.

For the purposes of this patent application, the term “melt” refers in particular to a state in which a mixture is plastically deformable. In this state, in an extruder or internal mixer, for example, it is possible to produce homogeneous mixtures or to shape mixtures. Because of the typically elastic nature of the polymer or polymers in the mixture, and because of the lack of thermoplasticity, the state attained in this case is not a melted state in which the mixture reaches the behavior of a liquid. This behavior relates to the homogeneous mixture and not to individual constituents of the mixture, which may indeed be present in the liquid or melted state. Thus, for example, the resins used in accordance with the invention customarily have a defined melting point.

A crosslinkable polymer as used in the PSA of the invention is workable—for example, coatable and/or shapable—when it is not yet crosslinked or is crosslinked only to a low degree; the degree of crosslinking of the crosslinkable polymer at the start of working, such as coating or shaping, is preferably not more than 10%, more preferably not more than 3%, and especially not more than 1% of the desired final degree of crosslinking. The crosslinking reaction preferably also continues after the cooling of the PSA, until the final degree of crosslinking is reached.

The concept of “cooling” here and hereinafter also includes the passive cooling as a result of removal of the heating.

In the context of the process of the invention, the crosslinking is initiated preferably at a point in time shortly before further processing, more particularly before shaping or coating. This takes place usually in a processing reactor (compounder—an extruder, for example). The composition is then taken from the compounder and subjected to further processing as desired. In the course of the further processing or thereafter, the PSA is cooled, by actively cooling and/or adjusting the heating, or by heating the PSA to a temperature below the working temperature (here as well, optionally, after active cooling beforehand), if the temperature is intended not to drop to room temperature.

The further processing may comprise in particular an operation of coating onto a permanent or temporary carrier.

A “permanent carrier” in accordance with the invention is a carrier which through its nature is joined firmly, and therefore permanently, to the bordering layer of PSA. In the application, therefore, a permanent carrier also remains joined to the bordering PSA layer. Permanent carriers which can be used are all known carriers, examples being laid scrims, woven, knitted and nonwoven fabrics, films, papers, tissues, foams, and foamed films, preferably foams. Suitable films are those, for example, of polypropylene, preferably oriented, polyesters such as PET, for example, or unplasticized and/or plasticized PVC. Also preferred are polyolefin foams, polyurethane foams, EPDM foams and chloroprene foams, especially EPDM foams. Polyolefin here means, in particular, polyethylene and polypropylene, with polyethylene being preferred on account of the plasticity. The term “polyethylene” includes LDPE, but also ethylene copolymers such as LLDPE and EVA. Especially suitable are crosslinked polyethylene foams or viscoelastic carriers. The viscoelastic carriers are preferably made of polyacrylate or of crosslinked EPDM, and especially of crosslinked EPDM, which preferably has a very low tack. The viscoelastic carriers are further preferably filled with hollow bodies of glass or polymers, especially with hollow glass spheres or expanded microballoons—such as, for example, expanded microballoons.

A permanent carrier may in accordance with the invention have been prepared, before being combined with the PSA, by priming, by physical pretreatment such as corona or by chemical pretreatment such as etching.

A “temporary carrier” refers in accordance with the invention to a carrier which by virtue of its nature can be removed again from the bordering layer of PSA. A temporary carrier of this kind is typically double-sidedly antiadhesively coated material, as for example a release paper (calendered paper, for example) or a release film (of polyester or polypropylene, for example) with antiadhesive release coating, preferably with silicone coating. Temporary carriers are also referred to as “liners”. If the liner is removed from the PSA layer within the ongoing processing operation itself, it is also referred to as a “process liner”.

In one advantageous variant of the process of the invention, the PSA of the invention is coated, during or after removal from the processing reactor, onto a permanent or temporary carrier and is cooled, during or after coating, to room temperature (or a temperature in the vicinity of room temperature), in particular immediately after coating.

Initiation, “shortly before” further processing means in particular that the organosilane of the formula (1) needed for crosslinking is added to the hotmelt (thus to the melt) as late as possible but as early as necessary in order to achieve effective homogenization with the polymer material.

The crosslinker is preferably selected such that the crosslinking reaction proceeds at a temperature below the melting temperature of the polymer material present in the PSA of the invention, especially at room temperature. The possibility of crosslinking at room temperature offers the advantage that no additional energy need be supplied during and/or after further processing, in order to achieve the final degree of crosslinking. Hence, for example, a final degree of crosslinking can also be achieved during storage at room temperature and without supply of energy.

The term “crosslinking at room temperature” here refers in particular to the crosslinking at usual storage temperatures of adhesive tapes, viscoelastic nontacky materials or the like, and is therefore not to be limited to 20° C. Of course it is also conceivable in accordance with the invention for the storage temperature to deviate from 20° C., owing to weather-related or other fluctuations in temperature, or for the room temperature to differ from 20° C. on account of local circumstances, and for crosslinking to proceed without further supply of energy.

The compounder used in accordance with the invention may especially be an extruder such as, for example, a planetary roll extruder and/or a twin-screw extruder. The mixture of crosslinkable polymer and tackifier resin is present in the melt in the compounder, either after having been already added in the melt stage or after having been heated to the melt state in the compounder. In the latter case, the tackifier resin may also be added in two or more portions. In the compounder, the mixture is maintained in the melt by heating.

While the crosslinker, i.e., the organosilane conforming to the formula (1), is not yet present in the mixture, the possible temperature in the melt is limited by the decomposition temperature of the polymer and/or of the tackifier resin. The process temperature in the compounder is customarily between 80 and 180° C., preferably between 100 and 150° C., such as 140° C., for example.

If an accelerator is used in the process of the invention, the crosslinker is added to the polymer preferably before or with the accelerator.

The crosslinker substances and, if intended, accelerator substances are added to the polymers preferably shortly before the further processing, especially shortly before the coating or other shaping. The time window for the addition prior to coating is guided in particular by the available pot life, in other words by the working time in the melt without deleterious change in the properties of the resultant product. With the process of the invention it has been possible to achieve pot lives of several minutes up to several tens of minutes (according to the experimental parameters selected), and so the crosslinker and, if intended, the accelerator ought to be added within this time span prior to coating. Ideally the crosslinker and/or accelerator is added to the hotmelt as late as possible but as early as necessary in order still to ensure effective homogenization with the polymer material.

Time spans which have emerged as being very advantageous for this purpose are 2 to 10 minutes, more particularly more than 5 minutes, at a process temperature of 100 to 150° C. such as, for example, 140° C.

The crosslinkers and, if intended, the accelerators may also both be added shortly before the further processing of the polymer. For this purpose it is advantageous to introduce the crosslinker and, where used, accelerator into the operation simultaneously at a single location.

In principle it is also possible to switch the times of addition and/or locations of addition of crosslinker and, where used, accelerator in accordance with the observations above, so that the accelerator is added before the crosslinker substances.

In the compounding operation, the temperature of the polymer on addition of the crosslinkers and/or accelerators is between 50 and 180° C., preferably between 80 and 150° C., more preferably between 100 and 150° C., and especially about 140° C.

After the composition has been compounded, it is processed further, in particular by coating onto a permanent or a temporary carrier.

The coating of the PSAs may take place, for example, with hotmelt coating nozzles known to the skilled person, or preferably with roll applicators, including coating calenders. The coating calenders may consist advantageously of two, three, four or more rolls.

Preferably at least one and more preferably all of the rolls that come into contact with the composition are provided with an anti-adhesive roll surface. Accordingly, it is possible for all of the rolls of the calender to have an anti-adhesive finish. An anti-adhesive roll surface used is with preference a steel-ceramic-silicone composite. Roll surfaces of this kind are resistant to thermal and mechanical loads. It is particularly advantageous to use roll surfaces which have a surface structure, more particularly of a kind such that the roll surface does not produce full contact with the PSA layer to be processed. This means that the area of contact is lower as compared with a smooth roll. Particularly advantageous are structured rolls such as engraved metal rolls—engraved steel rolls, for example.

Coating may take place in particular in accordance with the coating techniques as set out in WO 2006/027387 A1 at page 12 line 5 to page 20 line 13. The relevant disclosure content of WO 2006/027387 A1 is therefore explicitly included in the disclosure content of the present specification.

Particularly good results are achieved with two- and three-roll calender stacks through the use of calender rolls which are equipped with anti-adhesive or modified surfaces—particularly preferred are engraved metal rolls. These engraved metal rolls have a regularly geometrically interrupted surface structure. This applies with particular advantage to the transfer roll ÜW. The specific surfaces contribute in a particularly advantageous way to the success of the coating process, since anti-adhesive and structured surfaces allow the PSA to be transferred even to anti-adhesively treated carrier surfaces. Various kinds of anti-adhesive surface coatings can be used for the calender rolls. Those that have proved to be particularly suitable are, for example, the metal-ceramic-silicone composites Pallas SK-B-012/5 from Pallas Oberflächentechnik GmbH, Germany, and also AST 9984-B from Advanced Surface Technologies, Germany.

In the course of coating, particularly when using the multi-roll calenders, it is possible to realize coating speeds of up to 300 m/min.

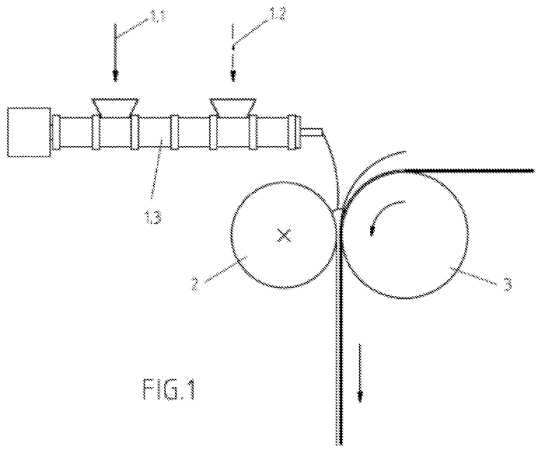

Shown by way of example in FIG. 1 of the present specification is the compounding and coating operation, on the basis of a continuous process. The polymers and tackifier resins are introduced at the first feed point 1.1 into the compounder 1.3, here for example an extruder. Either the introduction takes place already in the melt, or the polymers and tackifier resins are heated in the compounder until the melt state is reached.

Shortly before coating takes place, the organosilanes conforming to the formula (1) and, if intended, the accelerators are added at a second feed point 1.2. The success of this is that the crosslinkers and optionally accelerators are added to the polymers not until shortly before coating, and the reaction time in the melt is low.

The reaction regime may also be discontinuous. In corresponding compounders such as reactor tanks, for example, the addition of the polymers, the tackifier resins, the crosslinkers and optionally the accelerators may take place at different times and not, as shown in FIG. 1, at different locations.

The composition can then be coated using a roll applicator—represented in FIG. 1 by the doctor roll 2 and the coating roll 3—onto a liner or other suitable carrier. The rolls used preferably independently of one another have a temperature of 100 to 150° C., and more preferably of 110° C. to 140° C. For example, the doctor roll may have a temperature of 140° C. and the coating roll a temperature of 120° C. Directly after coating application the crosslinkable polymer is only slightly crosslinked, but not yet sufficiently crosslinked. The crosslinking reaction proceeds advantageously on the carrier.

After the coating operation, the PSA cools down relatively rapidly, in fact to the storage temperature, in general to room temperature. The crosslinker or crosslinker-accelerator system of the invention is preferably suitable for allowing the crosslinking reaction to continue without the supply of further thermal energy (without heat supply).

The crosslinking reaction between the carboxylic acid or carboxylic anhydride groups of the crosslinkable polymer and the radicals R¹ of the crosslinker and also between the hydrolyzable silyl groups of the crosslinker preferably proceeds completely even without heat supply under standard conditions (room temperature). Since the crosslinking occurs only when both of the above-described reactions take place, it may be of advantage for one of the two reactions to proceed at a rate such that it takes place partially or completely in the compounder itself. Generally speaking, after a storage time of no more than 5 to 14 days, crosslinking is concluded to a sufficient extent for there to be a functional product present, more particularly an adhesive tape or a functional carrier layer on the basis of the polymer. The ultimate state and thus the final cohesion of the polymer are attained, depending on the choice of polymer and of crosslinker or crosslinker-accelerator system, after a storage time of in particular 5 to 14 days, advantageously after 5 to 10 days' storage time at room temperature, and—as to be expected—earlier at a higher storage temperature.

Alternatively the PSA of the invention can be provided and processed—for example, coated onto a carrier—in the form of a solution, preferably having a solids content of 25 to 40 wt %, more preferably having a solids content of 30 to 35 wt %, such as of 32 wt %, for example, after which the solvent is evaporated off at an elevated temperature of preferably 100 to 150° C., such as 120° C. for example, and the PSA is crosslinked. The solution in question is preferably a solution in a mixture of benzine and isopropanol, the benzine used being especially benzine 60-95. The carrier may be a permanent or temporary carrier. At the elevated temperature of preferably 100 to 150° C., such as 120° C., for example, the crosslinking reaction proceeds preferably until the final degree of crosslinking is reached. For this purpose the PSA is subjected to the stated temperature typically over a period of 5 to 15 min, more particularly of 10 min. Alternatively the PSA, even before reaching the final degree of crosslinking, may be cooled, for example, to room temperature, and then crosslinks further until the final degree of crosslinking is reached, over a period of 5 to 14 days, for example.

Crosslinking raises the cohesion of the polymer and hence also the shear strength (under hot conditions as well). The connections are very stable. This enables very aging-stable and heat-resistant products such as adhesive tapes in particular.

The physical properties of the end product, especially its viscosity, peel adhesion and tack, can be influenced through the degree of crosslinking, and so the end product can be optimized through an appropriate choice of the reaction conditions. A variety of factors determine the operational window of the process. The most important influencing variables are the amounts (concentrations and proportions relative to one another) and the chemical natures of the crosslinkers and optionally of the accelerators, the operating temperature and coating temperature, the residence time in the compounder (especially extruder) and in the coating assembly, the fraction of functional groups, i.e., of carboxylic acid or carboxylic anhydride groups, in the crosslinkable polymer, and the average molecular weight of the crosslinkable polymer.

Described below are a number of associations related to the production of the inventively crosslinked PSA, which more closely characterize the production process.

For the dependency of the crosslinking time on the accelerator concentration at constant temperature it is found that the ultimate value of the degree of crosslinking remains virtually constant; at high accelerator concentrations, however, this value is achieved more quickly than at low accelerator concentrations.

In addition, the reactivity of the crosslinking reaction can also be influenced by varying the temperature, if desired, especially if the advantage of “inherent crosslinking” in the course of storage under standard conditions has no part to play. At constant crosslinker and optionally accelerator concentration, an increase in the operating temperature leads to a reduced viscosity, which enhances the coatability of the composition but reduces the working time.

An increase in the working time is acquired by a reduction in the accelerator concentration, reduction in polymer molecular weight, reduction in the concentration of functional groups (i.e., carboxylic acid/anhydride groups) in the polymer, use of less-reactive crosslinkers or of less-reactive crosslinker-accelerator systems, and/or reduction in operating temperature.

An improvement in the cohesion of the composition can be obtained by a variety of pathways. In one, the accelerator concentration is increased, which reduces the working time. At constant accelerator concentration, it is also possible to raise the molecular weight of the polymer used, moreover. In the sense of the invention it is advantageous in any case to raise the concentration of crosslinker.

Depending on the desired requirements profile of the composition or of the product it is necessary to adapt the abovementioned parameters in a suitable way.

The PSA of the invention can be used particularly for producing an adhesive tape. The expression “adhesive tape” in the sense of this invention encompasses all sheetlike structures such as two-dimensionally extended films or film sections, tapes with extended length and limited width, tape sections, diecuts, labels and the like. The adhesive tape is preferably in the form of a continuous web, as a roll, and not in the form of a diecut or label. The adhesive tape can be produced for example in the form of a roll, in other words in the form of an Archimedean spiral rolled up onto itself. For the purposes of the present invention a temporary carrier, in contrast to a permanent carrier, is not considered a constituent of an adhesive tape, but merely as an aid to its production (process liner) or as a means for its lining.

In the use of the PSA of the invention for producing an adhesive tape, a carrier is coated with the PSA and the PSA is crosslinked thermally to give a layer of a crosslinked PSA of the invention. The carrier may be a permanent carrier or a temporary carrier. “Coating a carrier with a PSA” in the context of the present patent application means in particular that the ready-made carrier is coated with the PSA. It may, however, also refer to the PSA being coextruded with the carrier. “Coating a carrier with a PSA” may also mean, in the present patent application, that the PSA is brought into direct contact with one surface of the carrier, i.e. is disposed directly on one surface of the carrier. Alternatively, however, it may also mean that the PSA is not brought directly into contact with a surface of the carrier, but instead at least one further layer is disposed between the carrier and the PSA when the carrier is being coated with the PSA. Preferably, for “coating a carrier with a PSA”, the PSA is brought into direct contact with one surface of the carrier. The carrier may selectively be coated on one side or on both sides with a PSA of the invention, and the PSA or PSAs of the invention are further thermally crosslinked. If the carrier is coated on both sides with a PSA of the invention, the two sides of the carrier may be coated either with PSAs of the invention that are identical in composition, or else with PSAs of the invention that differ in their composition; preferably, the PSAs of the invention are identical in composition. As already elucidated in more detail above, depending on the process for producing the adhesive tape, the thermal crosslinking of the PSA of the invention may take place only after the carrier has been coated with the PSA, or may commence even before, or during, the coating of the carrier with the PSA.

The PSA of the invention may be applied to a carrier material in a variety of processes. Depending on the equipment present, the target coat weight, reaction rate of the crosslinking, and solubility of the crosslinkable polymer, the PSA may be produced and coated from solution or from the melt, and alternatively by coating onto or coextrusion with the carrier.

The PSA of the invention is used preferably in the form of a melt. PSA layers with a thickness of more than around 80 μm are difficult to produce by the solvent technique, owing to problems which occur such as blistering, very low coating speed, problematic lamination of thin layers one above another, and weak points in the layered assembly. Suitable production procedures for a melt include both batch processes and continuous processes.

Alternatively, the PSA of the invention can be used in the form of a solution, preferably in a mixture of benzine and isopropanol, the benzine used being preferably benzine 60-95.

If the PSA of the invention is to be coated from a solution, the solution is produced beforehand by the processes known in the prior art. In particular, for example, the polymers are digested in a first portion of the solvent, and preswollen, in a suitable kneader (for example, a double-sigma kneader). Subsequently, the rest of the adjuvants are added simultaneously or with a staggering in terms of time, and at the end the desired solids content of the homogeneous mixture is established. The organosilanes and optionally accelerators that are added to the PSA of the invention are not incorporated homogeneously until shortly before the coating operation, in order to prevent premature crosslinking. Coating must then take place within the pot life or open time—that is, before the crosslinking has advanced to a point where uniform coating even in thin coat weights is no longer possible.

A solvent-containing PSA of the invention may be used for coating by the customary methods. In particular, the PSA may be applied to the carrier by means of a comma bar or Meyer bar or by means of an engraved roll. Alternatively, a nozzle may be used for coating, or the PSA is applied by spraying or in a screen printing process. Thereafter the solvent is removed in a suitable drying tunnel. The crosslinking of the PSA of the invention is typically accomplished largely during the drying operation itself, but may also take place separately and, for example, at the end of the drying tunnel, by means of infrared irradiation.

In the production of an adhesive tape of the invention it is possible optionally, besides at least one PSA of the invention, to use at least one further, arbitrary PSA as well. The further PSA may optionally in particular be thermally crosslinkable. It may further comprise one or more additives. Preferred additives are those also preferably present in a PSA of the invention. The statements made regarding preferred additives of the PSAs of the invention are therefore valid analogously for the further PSAs. If at least one further PSA is used in the production of an adhesive tape of the invention, the carrier is preferably coated on one side with a PSA of the invention, and this PSA is thermally crosslinked, and the carrier is coated with the further PSA on the side opposite the PSA of the invention, and this further PSA is crosslinked, if it is a crosslinkable PSA.

The PSA of the invention is used in particular for producing an adhesive tape in the form of a transfer tape, single-sided adhesive tape or a double-sided adhesive tape, and more particularly a double-sided adhesive tape.

A “transfer tape” of the invention refers to a single-layer crosslinked PSA of the invention. It therefore constitutes a single-layer, double-sidedly self-adhesive tape. The transfer tape is typically coated on one or both sides with a temporary carrier, i.e., with a liner. According to the present invention, a transfer tape is preferably produced by coating a temporary carrier with a PSA of the invention, thermally crosslinking the PSA, and optionally applying a further temporary carrier on the surface of the PSA layer opposite the temporary carrier.

A “single-sided adhesive tape” of the invention is an adhesive tape wherein a permanent carrier is coated on one of its surfaces with a crosslinked PSA of the invention. Preferably the single-sided adhesive tape consists exclusively of the permanent carrier and of the crosslinked PSA layer of the invention. Optionally there is a temporary carrier applied on the surface of the crosslinked PSA layer opposite the permanent carrier.

According to the present invention, a single-sided adhesive tape is produced preferably by

(i) coating a permanent carrier with a PSA of the invention, thermally crosslinking the PSA, and optionally applying a temporary carrier on the surface of the resultant crosslinked PSA layer opposite the permanent carrier, or
(ii) coating a temporary carrier with the PSA, thermally crosslinking the PSA, and applying a permanent carrier on the surface of the resultant crosslinked PSA layer opposite the temporary carrier.

A “double-sided adhesive tape” of the invention is an adhesive tape wherein a permanent carrier is coated on both of its surfaces with a PSA, and at least one of the two PSAs is a crosslinked PSA of the invention. With preference both PSAs and crosslinked PSAs of the invention. In the latter case the crosslinked PSAs may be identical or different in their composition; preferably they are identical in their composition. Also preferably, the double-sided adhesive tape consists exclusively of the permanent carrier and of the two PSA layers. Optionally in each case a temporary carrier is applied on the surfaces of the PSA layers opposite the permanent carrier.

According to one embodiment of a double-sided adhesive tape of the invention, a permanent carrier is coated on one of its two surfaces with a crosslinked PSA of the invention, and on the other of its two surfaces is coated with any other PSA. This other PSA may likewise be crosslinked, especially thermally. It may further comprise one or more additives. Preferred additives in that case are those also preferably present in a PSA of the invention. The statements made regarding preferred additives of the PSAs of the invention are therefore valid analogously for the other PSAs.

According to the present invention, a double-sided adhesive tape of the invention is produced preferably by coating two temporary carriers each independently of one another with a PSA of the invention, thermally crosslinking the PSAs, and additionally applying the surfaces of the resultant crosslinked PSA layers that are opposite the temporary carriers to the two surfaces of a permanent carrier. The two PSAs of the invention used may be identical or different in their composition, and preferably have an identical composition. An alternative embodiment of the production process may differ in that one of the two PSAs used is an arbitrary other PSA rather than a PSA of the invention. If the other PSA is likewise crosslinkable—thermally, for example—then it is also crosslinked during the production of the adhesive tape.

The coat weight of a PSA layer of the invention in the production of the adhesive tapes of the invention is preferably 10 to 5000 g/m², more preferably 15 to 3000 g/m², more preferably still 20 to 75 g/m², and especially about 50 g/m² (based in each case on the crosslinked PSA layer ultimately produced). On account in particular of the high shear strength after crosslinking, the PSAs of the invention are also suitable for use in adhesive tapes with a high coat weight of more than 100 g/m², such as, for example, more than 200 g/m². Even with such a high coat weight of PSA layer, it is possible in accordance with the process of the invention to achieve homogeneous crosslinking right through the layer. Examples of specific applications include industrial adhesive tapes, especially for use in the construction industry, examples being insulating tapes, anticorrosion tapes, aluminum bonding tapes, fabric-reinforced film adhesive tapes (duct tapes), special-purpose construction adhesive tapes, e.g., vapor barriers, adhesive assembly tapes, cable wrapping tapes; self-adhesive films and/or paper labels.

The present invention therefore also relates to an adhesive tape comprising at least one layer of a crosslinked PSA of the invention, i.e., of a PSA obtainable by thermal crosslinking of a PSA of the invention. The adhesive tape of the invention preferably comprises a permanent carrier coated with at least one layer of a crosslinked PSA of the invention. A “carrier coated with a PSA” means in accordance with the invention in particular that the ready-made carrier has been coated with the PSA. It may also be used, however, to mean that the PSA has been coextruded with the carrier. In accordance with the invention, furthermore, a “carrier coated with a PSA” may mean in one case that the PSA layer is in direct contact with one surface of the carrier, i.e., is disposed directly on one surface of the carrier. Alternatively in accordance with the invention, however, it may also mean that the PSA layer is not in contact directly with a surface of the carrier, but instead that there is at least one further layer disposed between the PSA layer and the carrier. In the case of a “carrier coated with a PSA”, preferably, the PSA layer is in direct contact with one surface of the carrier, i.e., it is preferably disposed directly on one surface of the carrier. The permanent carrier may selectively be coated on one or both sides with a crosslinked PSA of the invention. If the carrier is coated on both sides with a crosslinked PSA of the invention, then the two sides of the carrier may be coated either with crosslinked PSAs of the invention that are identical in their composition or else with crosslinked PSAs of the invention which differ in their composition; preferably the crosslinked PSAs of the invention are identical in their composition.

An adhesive tape of the invention may optionally comprise at least one further arbitrary PSA layer as well as at least one crosslinked PSA layer of the invention. The further PSA layer may optionally in particular be a thermally crosslinked PSA layer. It may further comprise one or more additives. Preferred additives in that case are those also preferably present in a crosslinked PSA layer of the invention. The statements made regarding preferred additives of the crosslinked PSAs of the invention are therefore valid analogously for the further PSAs. If an adhesive tape of the invention comprises at least one further PSA layer, the carrier is preferably coated on one side with a crosslinked PSA of the invention, and is coated with the further PSA on the side opposite the crosslinked PSA layer of the invention, with the further PSA optionally being a PSA which, in particular, is crosslinked thermally.

The adhesive tape of the invention is typically a transfer tape, a single-sided adhesive tape or a double-sided adhesive tape, with particular preference a double-sided adhesive tape. The transfer tape, the single-sided adhesive tape, and the double-sided adhesive tape in this case are defined as above.

In an adhesive tape of the invention, the coat weight of the at least one crosslinked PSA layer of the invention that is present therein, independently of one another, is 10 to 5000 g/m², preferably 15 to 3000 g/m², more preferably 20 to 75 g/m², and especially about 50 g/m².

The crosslinked PSA of the invention and an adhesive tape comprising at least one layer of a crosslinked PSA of this kind are very suitable for the bonding of low-energy surfaces such as, for example, apolar coatings, printing plates, polyethylene, polypropylene or EPDM, in other words, for example, for the closing or strapping of polyolefin bags or for the fastening of parts made of olefinic plastics or elastomers, and especially of plastic parts, to motor vehicles. They are therefore ideal for labels on cosmetics packaging (for example, for body lotion bottles or shampoo bottles), since they are highly transparent, adhere well to plastic bottles, and are water-resistant and stable to aging. In the context of security labels such as magnetic alarm labels or data carriers such as Holospot® (tesa Holospot® is a self-adheive polymer label containing an information field just a few square millimeters in size; the label adheres firmly to the product and contains various overt and covert security features, which are written into the information field beforehand using a high-resolution laser), they solve the problem of the poor adhesion of conventional adhesives to apolar substrates. They are additionally suitable for bonding to skin and to rough substrates in the construction sector, as adhesive packaging tape, and for wrapping applications. Examples of applications on skin are plasters in roll and individual form, diecuts for the bonding of colostomy bags and electrodes, active ingredient patches (transdermal patches), and bandages. On account of the aging stability, they offer the possibility for avoiding substances causing skin irritation or having other chemical actions. Consequently they are also suitable for the construction of hygiene products such as diaper closures, infant diapers or sanitary towels; furthermore, they adhere in particular to the polyolefin film and polyolefin nonwoven materials used in these contexts, and have lower costs and higher heat resistance than conventional compositions comprising hydrogenated styrene block copolymers. Examples of wrapping applications are electrical insulation and the production of automobile cable harnesses. The crosslinked PSA of the invention and the adhesive tape of the invention are also compatible at high temperatures with PP, PE and PVC wire insulation. In construction applications as plastering tape, for the bonding of roof insulation films (water vapor or liquid water barrier films) and as bitumen adhesive tape for sealing applications, and other outdoor applications, they are notable for effective bonding behavior under low-temperature conditions and for relatively good UV stability. Further applications are as adhesive splicing tapes for the continuous bonding of printed or unprinted film webs, and as adhesive barrier tape with respect to diffusion of moisture and oxygen in photovoltaic modules or electronic components.

The PSA layers in the adhesive tapes of the invention may for example be filled with organic or inorganic fillers. Also possible are layers foamed in open-cell or closed-cell form by known processes. A possible foaming method is that of foaming using compressed gases such as nitrogen or CO₂, or foaming using expandants such as hydrazines or expandable microballoons. Where expanding microballoons are used, the PSA or the shaped layer is advantageously activated suitably by means of introduction of heat. Foaming may take place in the extruder or after coating. It may be useful to smoothen the foamed layer using suitable rolls or release films. For producing foam-analogous layers, hollow glass spheres or already expanded polymeric microballoons may also be added to the PSA of the invention. The PSA layers of the adhesive tapes of the invention may also not be foamed.

### EXAMPLES

### Commercially Available Chemicals Used

| Chemical compound | Trade name | Manufacturer |
|---|---|---|
| EPDM (ethylene content 55 wt %, ENB | Vistalon ® 6602 | Exxon Mobil |
| content 5.2 wt %) | | |
| Maleic anhydride-grafted EPDM (ethylene | Keltan ® 1519r | Lanxess |
| content: 49 wt %, maleic anhydride content | | |
| (grafted): 1.9 wt %, Mooney viscosity | | |
| (ML 1 + 4/125° C.): 65) | | |
| White oil (paraffinic-naphthenic mineral oil) | Ondina ® 933 | Shell |
| Liquid EPDM (ethylene/propylene weight | Trilene ® 67 | Lion |
| ratio 46:54, ENB content: 9.5 wt %) | | Copolymers |
| Hydrogenated hydrocarbon resin (softening | Regalite ® R1100 | Eastman |
| temperature: 100° C.) | | |
| Alkylphenol resin based on octylphenol | SP ® 1045 | SI-Group |
| (softening temperature: 60-70° C.) | | |
| Zinc resinate (zinc complex of rosin) | Bremazit ® 3050 | Robert |
| | | Kramer |
| Trimethylol propane triacrylate (TMPTA) | | Sigma- |
| | | Aldrich |
| Dibenzoyl peroxide (BPO) | | Sigma- |
| | | Aldrich |
| (3-Glycidyloxypropyl)triethoxysilane | Dynasylan ® GLYEO | Evonik |
| 3-Aminopropyltriethoxysilane | Dynasylan ® AMEO | Evonik |
| Benzine 60-95 | Exxsol ® DSP 60/95 SH | Exxon Mobil |
| Isopropanol | | Helm AG |
| Ethanol | | Helm AG |
| Acetone | | Helm AG |

### Production of the PSAs and their Properties

Inventive examples 1 to 3 describe the production of PSAs of the invention based on maleic anhydride-grafted EPDM in the form of a solution, the coating of said solution onto a carrier from the solution, and the crosslinking of the PSAs to give crosslinked PSA layers of the invention.

Comparative example 4 describes the production of a crosslinker-free PSA based on maleic anhydride-grafted EPDM in the form of a solution and also the coating of that solution onto a carrier from the solution.

Inventive examples 5 and 6 describe the production of resole-containing PSAs based on EPDM in the form of a solution, the coating of that solution onto a carrier from the solution, and the crosslinking of the PSAs to give crosslinked PSA layers.

Inventive examples 7 and 8 describe the production of peroxide-containing PSAs based on EPDM in the form of a solution, the coating of that solution onto a carrier from the solution, and the crosslinking of the PSAs to give crosslinked PSA layers.

### Inventive Example 1

120 g of Keltan® 1519r, 242 g of benzine 60-95 and 13 g of isopropanol were combined, preswollen at 23° C. for 24 hours, and then kneaded in a kneader with double-sigma kneading hook at 35 rpm for 15 minutes. Then 133.2 g of Regalite® R1100 were added and the composition obtained was kneaded at 35 rpm for 60 minutes. Thereafter 45 g of Ondina® 933 were added and the resulting composition was kneaded at 35 rpm for 10 minutes. Subsequently 364 g of benzine 60-95 and 19 g of isopropanol were added and the resulting composition was kneaded at 35 rpm for 30 minutes. Then a solution of 1.3 g of 3-aminopropyltriethoxysilane in 42 g of benzine 60-95 was added and stirring was carried out for 1 minute. Thereupon a solution of 0.5 g of 3-glycidyloxypropyltriethoxysilane in 16 g of benzine 60-95 was added and stirring was carried out for 1 minute.

The resulting PSA was coated on a standard commercial laboratory coating bench (for example, from Sondermaschinen Oschersleben GmbH) with the aid of a coating knife onto a PET film 23 μm thick which had been etched with trichloroacetic acid. The solvent was evaporated off in a forced air drying cabinet at 120° C. for 10 minutes, during which the PSA began to crosslink. The slot width during coating was set so that the coat weight achieved following evaporation of the solvent was 50 g/m². The result was a crosslinked PSA layer.

### Inventive Example 2

A crosslinked PSA layer was produced as described in example 1, but adding 47 g of Trilene® 67 rather than 45 g of Ondina® 933.

### Inventive Example 3

A crosslinked PSA layer was produced as described in example 1, but adding 47 g of Trilene® 67 rather than 45 g of Ondina® 933. In a further departure from example 1, no (3-glycidyloxypropyl)triethoxysilane crosslinker was used, but only 3-aminopropyl-triethoxysilane. For this purpose, a solution of 2.1 g of 3-aminopropyltriethoxysilane in 68 g of benzine 60-95 was added and stirring was carried out for 1 minute.

### Comparative Example 4

120 g of Keltan® 1519r, 242 g of benzine 60-95 and 13 g of isopropanol were combined, preswollen at 23° C. for 24 hours, and then kneaded in a kneader with double-sigma kneading hook at 35 rpm for 15 minutes. Then 133.2 g of Regalite® R1100 were added and the composition obtained was kneaded at 35 rpm for 60 minutes. Thereafter 45 g of Ondina® 933 were added and the resulting composition was kneaded at 35 rpm for 10 minutes. Subsequently 364 g of benzine 60-95 and 19 g of isopropanol were added and the resulting composition was kneaded at 35 rpm for 30 minutes. kneaded. Then a solution of 1.3 g of 3-aminopropyltriethoxysilane in 42 g of benzine 60-95 was added and stirring was carried out for 1 minute. Thereupon a solution of 0.5 g of 3-glycidyloxy-propyltriethoxysilane in 16 g of benzine 60-95 was added and stirring was carried out for 1 minute.

The resulting PSA was coated on a standard commercial laboratory coating bench (for example, from Sondermaschinen Oschersleben GmbH) with the aid of a coating knife onto a PET film 23 μm thick which had been etched with trichloroacetic acid. The solvent was evaporated off in a forced air drying cabinet at 120° C. for 10 minutes, and so the resultant PSA layer is substantially free of solvent. The slot width during coating was set so that the coat weight achieved following evaporation of the solvent was 50 g/m².

### Comparative Example 5

115.5 g of Vistalon® 6602 and 213 g of benzine 60-95 were combined, preswollen at 23° C. for 48 hours, and then kneaded in a kneader with double-sigma kneading hook at 35 rpm for 15 minutes. Then 125.4 g of Regalite® R1100 were added and the composition obtained was kneaded at 35 rpm for 60 minutes. Thereafter 39 g of Ondina® 933 were added and the resulting composition was kneaded at 35 rpm for 10 minutes. 14.1 g of SP® 1045 (crosslinker resin) and 5.9 g of Bremazit® 3050 (zinc resinate) were dissolved in 20 g of ethanol, added together with a first diluent amount of 192 g of benzine 60-95, and the resulting composition was kneaded at 35 rpm for 20 minutes. Thereafter a second diluent amount of 213 g of benzine 60-95 was added and was incorporated by kneading at 35 rpm for 30 minutes.

The resulting PSA was coated on a standard commercial laboratory coating bench (for example, from Sondermaschinen Oschersleben GmbH) with the aid of a coating knife onto a PET film 23 μm thick which had been etched with trichloroacetic acid. The solvent was evaporated off in a forced air drying cabinet at 105° C. for 10 minutes. The slot width during coating was set so that the coat weight achieved following evaporation of the solvent was 50 g/m². Subsequently the film freed of the solvent was crosslinked at 180° C. for 40 minutes. The result was a resole-crosslinked PSA layer.

### Comparative Example 6

87.3 g of Vistalon® 6602 and 213 g of benzine 60-95 were combined, preswollen at 23° C. for 48 hours, and then kneaded in a kneader with double-sigma kneading hook at 35 rpm for 15 minutes. Then 132.6 g of Regalite® R1100 were added and the composition obtained was kneaded at 35 rpm for 60 minutes. Thereafter 60 g of Trilene® 67 were added and the resulting composition was kneaded at 35 rpm for 10 minutes. 14.1 g of SP® 1045 (crosslinker resin) and 5.9 g of Bremazit® 3050 (zinc resinate) were dissolved in 20 g of ethanol, added together with a first diluent amount of 192 g of benzine 60-95, and the resulting composition was kneaded at 35 rpm for 20 minutes. Thereafter a second diluent amount of 213 g of benzine 60-95 was added and was incorporated by kneading at 35 rpm for 30 minutes.

The resulting PSA was coated on a standard commercial laboratory coating bench (for example, from Sondermaschinen Oschersleben GmbH) with the aid of a coating knife onto a PET film 23 μm thick which had been etched with trichloroacetic acid. The solvent was evaporated off in a forced air drying cabinet at 105° C. for 10 minutes. The slot width during coating was set so that the coat weight achieved following evaporation of the solvent was 50 g/m². Subsequently the film freed of the solvent was crosslinked at 180° C. for 40 minutes. The result was a resole-crosslinked PSA layer.

### Comparative Example 7

121.2 g of Vistalone 6602 and 213 g of benzine 60-95 were combined and preswollen at 23° C. for 48 hours. Then 127.2 g of Regalite® R1100 were added and the composition obtained was kneaded at 35 rpm for 60 minutes. Thereafter 39.9 g of Ondina® 933 were added and the resulting composition was kneaded at 35 rpm for 10 minutes. A first dilution was carried out with 212 g of benzine 60-95, which was incorporated by kneading at 35 rpm for 20 minutes. Together with a second dilution of 213 g of benzine 60-95, 2.9 g of TMPTA were added and the resulting composition was kneaded at 35 rpm for 30 minutes. Shortly before coating, 8.7 g of BPO as a 10 wt % strength solution in acetone were added and incorporated by kneading for 20 minutes.

The resulting PSA was coated on a standard commercial laboratory coating bench (for example, from Sondermaschinen Oschersleben GmbH) with the aid of a coating knife onto a PET film 23 μm thick which had been etched with trichloroacetic acid. The solvent was evaporated off in a forced air drying cabinet at 120° C. for 10 minutes, during which the PSA began to crosslink. The slot width during coating was set so that the coat weight achieved following evaporation of the solvent was 50 g/m². The result was a peroxide-crosslinked PSA layer.

### Comparative Example 8

90 g of Vistalon® 6602 and 213 g of benzine 60-95 were combined and preswollen at 23° C. for 48 hours. Then 138.3 g of Regalite® R1100 were added and the composition obtained was kneaded at 35 rpm for 60 minutes. Thereafter 60 g of Trilene® 67 were added and the resulting composition was kneaded at 35 rpm for 10 minutes. A first dilution was carried out with 212 g of benzine, which was incorporated by kneading at 35 rpm for 20 minutes. Together with a second dilution of 213 g of benzine 60-95, 2.9 g of TMPTA were added and the resulting composition was kneaded at 35 rpm for 30 minutes. Shortly before coating, 8.7 g of BPO as a 10 wt % strength solution in acetone were added and incorporated by kneading for 20 minutes.

The resulting PSA was coated on a standard commercial laboratory coating bench (for example, from Sondermaschinen Oschersleben GmbH) with the aid of a coating knife onto a PET film 23 μm thick which had been etched with trichloroacetic acid. The solvent was evaporated off in a forced air drying cabinet at 120° C. for 10 minutes, during which the PSA began to crosslink. The slot width during coating was set so that the coat weight achieved following evaporation of the solvent was 50 g/m². The result was a peroxide-crosslinked PSA layer.

### Inventive Examples 9 to 11

Alternatively, inventive examples 1-3 were likewise produced solventlessly in an extruder by the processes described in DE19806609A1 (inventive examples 9 to 11). This was done using a planetary roll extruder from ENTEX Rust & Mitschke, with three roll cylinders. The diameter of a roll cylinder was 70 mm, and its process length was 1200 mm. The central spindle was conditioned to 18° C., the roll cylinders to 90° C. The conveying screw was operated with 75 revolutions per minute, and each roll cylinder contained 7 planetary spindles.

The solid EPDM rubbers were fed to the conveying screw via the filling port. The melted tackifier resins were added via a melt pump at the start of the second roll cylinder, while the plasticizers were fed into the thrust ring between the second and third roll cylinders. The homogeneous mixture was subsequently transferred for degassing into a degassing twin-screw extruder. In this extruder the organosilanes were added and incorporated. After the degassing, the extrudate was passed directly onto the roll applicator for the coating of the PSAs.

The properties of the specimens produced in a hotmelt process corresponded to those of the specimens from the solvent process as described above (inventive examples 1 to 3).

Results:

Table 1 provides an overview of the adhesive and mechanical properties of the crosslinked PSAs of the invention from inventive examples 1 to 3, and also those of the comparative adhesives from comparative examples 4 to 8.

| | | Crosslinker system: | | Peel adhesion | MST (200 g)² | MST (1000 g)³ | SAFT⁴ |
|---|---|---|---|---|---|---|---|
| Experiment | EPDM | type and proportion¹ | Plasticizer | [N/cm] | [μm] | [μm] | (° C.) |
| Inventive | Keltan ® | 0.4 wt % Dynasylan ® AMEO | Ondina ® 933 | 5.5 | 10 | 213 | 150 |
| example 1 | 1519r | 0.2 wt % Dynasylan ® GLYEO | | | | | |
| Inventive | Keltan ® | 0.4 wt % Dynasylan ® AMEO | Trilene ® 67 | 8.1 | 19 | 248 | 142 |
| example 2 | 1519r | 0.2 wt % Dynasylan ® GLYEO | | | | | |
| Inventive | Keltan ® | 0.7 wt % Dynasylan ® AMEO | Trilene ® 67 | 8.1 | 18 | 236 | 157 |
| example 3 | 1519r | | | | | | |
| Comparative | Keltan ® | — | Ondina ® 933 | 7.7 | 43 | 366 | 113 |
| example 4 | 1519r | | | | | | |
| Comparative | Vistalon ® | 4.7 wt % SP ® 1045 | Ondina ® 933 | 2.8 | 613 | >2000 | 89 |
| example 5 | 6602 | 2.0 wt % Zn resinat | | | | | |
| Comparative | Vistalon ® | 4.7 wt % SP ® 1045 | Trilene ® 67 | 3.4 | 536 | >2000 | 92 |
| example 6 | 6602 | 2.0 wt % Zn resinat | | | | | |
| Comparative | Vistalon ® | 2.9 wt % dibenzoyl peroxide | Ondina ® 933 | 2.5 | 314 | >2000 | 110 |
| example 7 | 6602 | 1.0 wt % TMPTA | | | | | |
| Comparative | Vistalon ® | 2.9 wt % dibenzoyl peroxide | Trilene ® 67 | 2.8 | 284 | >2000 | 116 |
| example 8 | 6602 | 1.0 wt % TMPTA | | | | | |

¹Proportion = proportion by weight in the PSA prior to crosslinking (in wt %, based on the solvent-free proportion);
²MST (200 g) = microshear travel on loading with a weight of 200 g;
³MST (1000 g) = microshear travel on loading with a weight of 1000 g;
⁴SAFT = Shear Adhesion Failure Temperature (tesa-SAFT), heat resistance.

The organosilane-crosslinked PSAs of the invention, based on maleic anhydride-grafted EPDM, from the adhesive tapes of inventive examples 1 to 3, have much higher shear strengths, under hot conditions as well, than a corresponding noncrosslinked PSA likewise based on maleic anhydride-grafted EPDM, of the kind present in the adhesive tape from comparative example 4. They are therefore much more heat-resistant. This is evident in the microshear travel at 40° C., reduced relative to comparative example 4, even under different levels of force exposure, and also in increased SAFT temperatures (“Shear Adhesion Failure Temperatures”) of the adhesive tapes of the invention from inventive examples 1 to 3. The heat resistances of the adhesive tapes from inventive examples 1 to 3 additionally show that the heat resistance can be additionally adjusted through the nature of the plasticizer used and/or through the nature and amount of the organosilane crosslinker used.

Comparing the peel adhesion, i.e., the peel strength, of the adhesive tapes of the invention from inventive examples 1 to 3 with the peel adhesion of the adhesive tape from comparative example 4, it is further found that with the organosilane-crosslinked PSA layers of the invention, based on maleic anhydride-grafted EPDM, despite the crosslinking, it is possible to obtain peel adhesion comparative with that of corresponding noncrosslinked PSA layers likewise based on maleic anhydride-grafted EPDM. The comparison of the adhesive tape from inventive example 1 with the adhesive tapes from inventive examples 2 and 3 shows, furthermore, that the peel adhesion can be significantly boosted further by using liquid EPDM in the PSA. Since the peel adhesion was determined in each case relative to a polypropylene plate and hence relative to an LSE surface, it is clear, furthermore, that the organosilane-crosslinked adhesive-composition layers of the invention, like the corresponding noncrosslinked layers of adhesive composition, are outstandingly suitable for adhesive bonding, including on LSE surfaces.

The organosilane-crosslinked PSAs of the invention based on maleic anhydride-grafted EPDM from inventive examples 1 to 3 are also significantly superior to the resole-crosslinked and peroxide-crosslinked PSAs based on EPDM from comparative examples 5 to 8, this superiority existing in respect both of the peel adhesion and of the heat resistance, i.e., shearing force at elevated temperature. This is evident from the microshear travel values, which are lower by a multiple factor, and also by the elevated SAFT values for the organosilane-crosslinked PSAs of the invention relative to the resole- or peroxide-crosslinked PSAs.

### Measurement Methods

All of the measurements were conducted unless otherwise specified at 23° C. and 50% relative humidity. Ahead of the tests described below, the specimens were stored for 7 days at 23° C. and 50% relative humidity in order to ensure complete post-crosslinking.

The data were determined as follows:

### Solids Content

The solids content is a measure of the fraction of unevaporable constituents in a PSA. It is determined gravimetrically by weighing out the PSA, then evaporating the evaporable fractions in a drying cabinet at 120° C. for 2 hours and reweighing the residue.

### Thickness

The thickness of a PSA layer can be determined by determining the thickness of a section of such a layer of adhesive, applied to a carrier or liner, said section being of defined length and defined width, with subtraction of the (known or separately ascertainable) thickness of a section with the same dimensions as the carrier or liner used. The thickness of the layer of adhesive can be ascertained using commercial thickness gauges (sensor instruments) with accuracies of less than 1 μm deviation. Where fluctuations in thickness are found, the value reported is the average value of measurements at not less than three representative points—in other words, in particular, not including measurement at wrinkles, creases, specks and the like.

### Coat Weight

The coat weight of a PSA layer in g/m² can be determined by determining the mass of a section of such a layer of adhesive, applied to a carrier or liner, said section being of defined length and defined width, with subtraction of the (known or separately ascertainable) mass of a section with the same dimensions of the carrier or liner used.

### Softening Point

The softening point, also called softening temperature, of a resin is carried out according to the relevant methodology, which is known as ring & ball and is standardized according to ASTM E28.

### 180° Peel Adhesion Test

The peel strength (peel adhesion) is tested in a method based on PSTC-1.

A single-sided adhesive tape in the form of a strip 2 cm wide is adhered to a polypropylene plate 5 mm thick, by the free PSA side, by rolling down the tape back and forth five times using a 4 kg roller. The plate is clamped in, and the adhesive tape is pulled off by its free end on a tensile testing machine at a peel angle of 180° with a velocity of 300 mm/min. The results of measurement are reported in N/cm and are averages from three measurements.

### Shear Adhesion Failure Temperature (SAFT), Heat Resistance

This test is used for accelerated testing of the shear strength of adhesive tapes under temperature load. For the test, the single-sided adhesive tape under investigation is adhered by the PSA side to a heatable steel plate, loaded with a weight (50 g), and the shear travel is recorded.

Sample Preparation:

The single-sided adhesive tape is cut to a size of 10 mm*50 mm.

The adhesive tape cut to size is bonded by the free PSA side to a polished steel test plate cleaned with acetone (steel material 1.4301, DIN EN 10088-2, surface 2R, surface roughness Ra=30 to 60 nm, dimensions 50 mm*13 mm*1.5 mm) in such a way that the bond area of the sample is 13 mm*10 mm—height*width—and the steel test plate protrudes by 2 mm at the upper edge. The bond is then fixed by rolling a 2 kg steel roller over it six times at a speed of 10 m/min. At the top, the sample is reinforced flush with a stable adhesive strip which serves as a support for the travel sensor. Using the steel plate, the sample is then suspended so that the adhesive tape end with the longer overhang points vertically downward.

Measurement:

The sample for measurement is loaded at the bottom end with a 50 g weight. The steel test plate with the bonded sample is heated to the end temperature of 200° C., beginning at 30° C. and at a rate of 9 K/min.

The slip travel of the sample is observed by means of a travel sensor, as a function of temperature and time. The maximum slip travel is set at 1000 μm (1 mm); if it is exceeded, the test is discontinued and the failure temperature is noted.

Test conditions: room temperature 23+/−3° C., relative humidity 50+/−5%.

### Microshear Test

This test serves for the accelerated testing of the shear strength of adhesive tapes under temperature load.

Sample Preparation for Microshear Test:

A single-sided adhesive tape (length around 50 mm, width 10 mm) cut from the respective sample specimen is adhered by the PSA side to a steel test plate which has been cleaned with acetone, the bond being such that the steel plate protrudes beyond the adhesive tape to the right and to the left, and the adhesive tape protrudes beyond the test plate by 2 mm at the upper edge. The bond area of the sample in terms of height×width=13 mm×10 mm. The bond site is subsequently rolled down six times with a 2 kg steel roller at a speed of 10 m/min. The adhesive tape is reinforced flush with a stable adhesive strip which serves as a support for the travel sensor. The sample is suspended vertically by means of the test plate.

Microshear Test:

The sample specimen for measurement is loaded at the bottom end with a weight of 200 g (variant 1) or 1000 g (variant 2). The test temperature is 40° C. in each case, the test load duration 15 minutes. The shear travel after the predetermined test duration at constant temperature is reported as the result in μm.

### Surface Energies

Surface energies (surface tensions) are determined according to DIN ISO 8296. This can be done using, for example, test inks from Softal. The inks are available in the range from 30 to 72 mN/m. The ink is applied, with a line of ink to the surface, at 23° C. and 50% relative humidity. If the line of ink contracts in less than 2 seconds, the measurement is repeated with ink of a lower surface energy until the 2 seconds are reached. If the line of ink remains unchanged for longer than 2 seconds, the measurement is repeated with ink of higher surface energy until the 2 seconds are reached. The FIGURE indicated on the corresponding ink bottle then corresponds to the surface energy of the substrate.

1. A pressure sensitive adhesive composition comprising:
a) at least one crosslinkable polymer constructed at least of (i) at least two monomers selected from monomer A, monomer B, and monomer C, wherein each monomer, independently of one another, comprises an olefinically unsaturated aliphatic or cycloaliphatic hydrocarbon, and (ii) at least one comonomer D comprising an olefinically unsaturated monomer having at least one carboxylic acid group and/or carboxylic anhydride group;
b) at least one organosilane conforming to the formula (1)
R¹—Si(OR²)ₙR³ₘ (1),
wherein R¹ is a radical able to enter into a chemical bond with a carboxylic acid group or with a carboxylic anhydride group,
the radicals R² independently of one another are each a hydrogen, an alkyl, a cycloalkyl, an aryl or an acyl radical,
R³ is a hydrogen, an alkyl, a cycloalkyl or an aryl radical,
n is 2 or 3, and
m is the number resulting from 3-n; and
c) at least one tackifier resin.

2. The pressure sensitive adhesive composition of claim 1, wherein the at least two monomers are α-olefins having 2 to 8 carbon atoms selected from ethylene, propylene, 1-hexene, 1-octene, 5 ethylidene-2-norbornene, dicyclopentadiene, and 5-vinyl-2-norbornene.

3. The pressure sensitive adhesive composition of claim 2, wherein the monomer A is ethylene, the monomer B is propylene, and the monomer C, if present, is a diene selected from 5-ethylidene-2-norbornene, dicyclopentadiene, and 5-vinyl-2-norbornene.

4. The pressure sensitive adhesive composition of claim 3, wherein the diene is 5-ethylidene-2-norbornene.

5. The pressure sensitive adhesive composition of claim 1, wherein the comonomer D is acrylic acid, methacrylic acid, maleic acid, maleic anhydride, fumaric acid, fumaric anhydride, methylmaleic acid, methylfumaric acid, itaconic acid, crotonic acid, crotonic anhydride, 4-methylcyclohex-4-ene-1,2-dicarboxylic anhydride, bicyclo[2.2.1]hept-5-ene-2,3-dicarboxylic anhydride, bicyclo[2.2.1]hept-5-ene-2,3-dicarboxylic acid, bicyclo[2.2.2]oct-5-ene-2,3-dicarboxylic acid, bicyclo[2.2.2]oct-5-ene-2,3-dicarboxylic anhydride, bicyclo[2.2.2]oct-7-ene-2,3,5,6-tetracarboxylic acid, bicyclo[2.2.2]oct-7-ene-2,3,5,6-tetracarboxylic anhydride, 5-norbornene-2,3-dicarboxylic acid, norborn-5-ene-2,3-dicarboxylic anhydride, tetrahydrophthalic acid, and tetrahydrophthalic anhydride.

6. The pressure sensitive adhesive composition of claim 1, wherein the crosslinkable polymer is obtainable by copolymerization at least of the at least two monomers to give a polymer, and grafting of the comonomer D onto the polymer.

7. The pressure sensitive adhesive composition of claim 1, wherein the crosslinkable polymer is obtainable by copolymerization at least of the at least two monomers with the comonomer D.

8. The pressure sensitive adhesive composition of claim 1, wherein the crosslinkable polymer has a Mooney viscosity (ML 1+4/125° C.), measured according to DIN 53523, of more than 25.

9. The pressure sensitive adhesive composition of claim 1, wherein the radicals R² of the organosilane of the formula (1) independently of one another are each an alkyl group or acetyl group.

10. The pressure sensitive adhesive composition of claim 1, wherein the radical R³ of the organosilane of formula (1), if present, is an alkyl group selected from a methyl group, an ethyl group, a propyl group, and an isopropyl group.

11. The pressure sensitive adhesive composition of claim 1, wherein the radical R¹ of the organosilane of the formula (1) is at least one hydroxyl group, at least one thio group, at least one amino group NHR⁴, wherein R⁴ is a hydrogen, alkyl, cycloalkyl or aryl radical, or a mixture thereof, and, if R⁴ is an alkyl or cycloalkyl radical, this radical optionally comprises at least one further amino group NHR⁴, at least one hydroxyl group, at least one thio group, or a mixture thereof.

12. The pressure sensitive adhesive composition of claim 11, wherein the radical R¹ comprises at least one amino group NHR⁴.

13. The pressure sensitive adhesive composition of claim 12, wherein the radical R¹ is an X—(CH₂)—(CH₂)ₚ radical where X is a hydroxyl group, a thio group or an amino group NHR⁴, wherein R⁴ is a hydrogen, alkyl, cycloalkyl or aryl radical, and p is an integer from 0 to 10,
and, if R⁴ is an alkyl or cycloalkyl radical, this radical optionally comprises at least one further amino group NHR⁴, at least one hydroxyl group, at least one thio group, or a mixture thereof.

14. The pressure sensitive adhesive composition of claim 13, wherein the organosilane of the formula (1) is N-cyclohexyl-3-aminopropyltrimethoxysilane, N-cyclohexylaminomethyl-triethoxysilane, 3-aminopropyltrimethoxysilane, 3-aminopropyltriethoxysilane, 3-aminopropylmethyldiethoxysilane, 3-(2-aminomethylamino)propyltriethoxysilane, or a mixture thereof.

15. The pressure sensitive adhesive composition of claim 11, wherein the radical R¹ of the organosilane of the formula (1) is a radical comprising at least one cyclic ether function.

16. The pressure sensitive adhesive composition of claim 15, wherein R¹ comprises at least one epoxide group, at least one oxetane group, or a mixture thereof.

17. The pressure sensitive adhesive composition of claim 16, wherein R¹ comprises at least one glycidyloxy group, at least one epoxycyclohexyl group, at least one epoxyhexyl group, at least one oxetanylmethoxy group, or a mixture thereof.

18. The pressure sensitive adhesive composition of claim 17, wherein R¹ is a Y—(CH₂)—(CH₂)_{q} radical, where Y is a group as defined in claim 17 and q is an integer from 0 to 10.

19. The composition of claim 17, wherein the organosilane of the formula (1) is (3-glycidyloxy-propyl)trimethoxysilane, (3-glycidyloxypropyl)triethoxysilane, (3-glycidyloxypropyl)methyldimethoxysilane, (3-glycidoxypropyl)-methyldiethoxysilane, 5,6-epoxyhexyltriethoxysilane, [2-(3,4-epoxycyclo-hexyl)ethyl]trimethoxysilane, [2-(3,4-epoxycyclohexyl)ethyl]triethoxysilane, triethoxy[3-[(3-ethyl-3-oxetanyl)methoxy]propyl]silane, or a mixture thereof.

20. The pressure sensitive adhesive composition of claim 15, wherein the pressure sensitive adhesive composition comprises the one organosilane and the at least one organosilane.

21. The pressure sensitive adhesive composition of claim 1, further comprising:
at least one additional polymer constructed of ethylene, propylene and optionally a diene, where the diene, if present, is 5-ethylidene-2-norbornene, dicyclopentadiene, or 5-vinyl-2-norbornene.

22. The pressure sensitive adhesive composition of claim 21, wherein the at least one additional polymer is solid or liquid, possessing a Mooney viscosity (ML 1+4/125° C.), measured according to DIN 53523, of less than 25.

23. A method comprising:
thermal crosslinking the pressure sensitive adhesive composition of claim 1 to obtain a crosslinked pressure sensitive adhesive composition.

24. A method for producing an adhesive tape, the method comprising:
coating a carrier with the pressure sensitive adhesive composition of claim 1; and
thermally crosslinking the pressure sensitive adhesive composition to give a layer of a crosslinked pressure sensitive adhesive.

25. An adhesive tape comprising:
at least one layer of the crosslinked pressure sensitive adhesive obtained by the method of claim 23.
